(19) United States
(12) Patent Application Publication
(10) Pub. No.: US 2026/0086207 A1
(43) Pub. Date: Mar. 26, 2026

(54) LIDAR Sensor System with Glass Block for Optical Edge Coupling

(71) Applicant: Aurora Operations, Inc., Pittsburgh, PA (US)

(72) Inventors: Colin Delaney, Bozeman, MT (US); James Ferrara, Oakland, CA (US); Michael Chia Huang, San Jose, CA (US); Pruthvi Jujjavarapu, Palo Alto, CA (US); Yongxuan Liang, Fremont, CA (US); Sen Lin, Mountain View, CA (US); Andrew Steil Michaels, Los Altos, CA (US); Parth Panchal, San Jose, CA (US); Zhizhong Tang, Palo Alto, CA (US); Lei Wang, Fremont, CA (US)

(21) Appl. No.: 18/897,929

(22) Filed: Sep. 26, 2024

(51) Int. Cl. G01S 7/481; G01S 7/497; G01S 17/04; G01S 17/931; G02B 6/26

(52) U.S. Cl. CPC G01S 7/4816; G01S 7/4818; G01S 7/497; G01S 17/04; G01S 17/931; G02B 6/262

(57) ABSTRACT

A Light Detection and Ranging (LIDAR) sensor system includes an optical system, including: a first optical component formed of a first semiconductor material; a second optical component formed of a second semiconductor material; a glass block disposed on a first side of the first optical component and a first side of the second optical component, the glass block including a plurality of micro-channels; and a coupling material, disposed in the plurality of micro-channels, between the first side of the first optical component and the glass block and between the first side of the second optical component and the glass block.

### BACKGROUND

Light Detection and Ranging (LIDAR) systems use lasers to create three-dimensional representations of surrounding environments. A LIDAR system includes at least one emitter paired with a receiver to form a channel, though an array of channels may be used to expand the field of view of the LIDAR system. During operation, each channel emits a laser beam into the environment. The laser beam reflects off of an object within the surrounding environment, and the reflected laser beam is detected by the receiver. A single channel provides a single point of ranging information. Collectively, channels are combined to create a point cloud that corresponds to a three-dimensional representation of the surrounding environment.

The emitter and/or receiver often includes photonic circuitry formed on a semiconductor substrate such as a silicon die. Silicon photonics dies can provide for precise formation of the photonic circuitry through, for example, photolithography. Other optical components of a LIDAR sensor system may also be formed on semiconductor substrates, while still others are formed on or connected to components made using other semiconductor materials such as, for example, a group III-V semiconductor, gallium arsenide (GaAs), and/or other suitable materials.

### SUMMARY

Aspects and advantages of implementations of the disclosure will be set forth in part in the following description, or may be learned from the description, or may be learned through practice of the implementations.

Example aspects of the disclosure also relate to a LIDAR sensor system including a glass block which is implemented to couple a first optical component with a second optical component. Example aspects of the disclosure also relate to a method of manufacturing a LIDAR sensor system (e.g., a semiconductor optical system for a semiconductor-based LIDAR sensor system for a vehicle), the semiconductor optical system (e.g., a semiconductor optical assembly, a photonics module, etc.) having the glass block which is implemented to couple the first optical component with the second optical component.

To achieve the integration of many optics and photonic components into small form factor modules or systems, for example, an integrated LIDAR module, multiple semiconductor chips (silicon photonic chips, III-V chips, etc.) may be coupled directly together (e.g., butt-coupled or edge-coupled). For example, in optical and optoelectronic packaging, direct optical butt-coupling (also referred to as edge-coupling) may be used to couple a first waveguide to a second waveguide by providing a polymer material into a gap between the first and second waveguides. An alignment accuracy between the first and second waveguides may be required to be about two micrometers or less than one micrometer.

Unlike glass, semiconductor chips/materials (e.g., formed of silicon, GaAs, InP, etc.) absorb ultraviolet (UV) light. That is, the semiconductor chips/materials are UV non-transparent. When a polymer material of a minimal thickness (e.g., about two micrometers or less) is provided between two semiconductor chips to couple (e.g., butt-couple) the semiconductor chips and the coupling bonding area is relatively large (e.g., multiple millimeter or centimeter square), problems may occur when exposing or curing the polymer material via a light source (e.g., an UV light source). For example, UV light may not reach a shadowed region between the two semiconductor chips which are closely placed together, and only a small portion of the outer area of the polymer material (e.g., UV material) may be exposed/cured by the light source. Therefore, the polymer material (e.g., UV material) in the shadowed region that was not exposed to the light may remain in a liquid state. In such a case, the two semiconductor chips may not be mechanically bonded together because the UV material is still mostly liquid. Accordingly, the two semiconductor chips may not be sufficiently bonded together, and alignment issues (e.g., alignment accuracy) between the two semiconductor chips may be encountered.

According to examples of the disclosure, a LIDAR sensor system includes a glass block which is implemented to couple a first optical component with a second optical component by providing a coupling material between the first optical component and the glass block and between the second optical component and the glass block. The configuration of the glass block can secure the first and second optical components in a reliable manner with sufficient mechanical strength so that the first and second optical components are properly aligned.

In some implementations, the glass block may be positioned over (above) the first and second optical components which are butt-coupled together in an end-to-end manner. For example, the first and second optical components may be silicon chips. In some implementations, the first and second optical components may have the same height and width, however they may have different sizes. For example, the glass block can be shaped as a rectangular prism (e.g., having a cubic shape). However, the glass block may be shaped differently in other implementations. For example, the glass block may have a length or width of about a few hundred micrometers to about a few tenths of a millimeter. For example, the glass block may have a thickness (e.g., in a vertical direction from a side of the glass block which faces the first and/or second optical component to an opposite side of the glass block) of about a few hundred micrometers to about less than one hundred millimeters.

In some implementations, each of the first and second optical components may include a waveguide (e.g., a four-channel waveguide). In an example implementation, the waveguides may be positioned at a same height, and for example, at a same distance from a particular surface (e.g., a top surface) of the first and second optical components.

In some implementations, the glass block may be positioned in a symmetrical manner on a first surface (e.g., a top surface) of the first and second optical components such that a second surface (e.g., a bottom surface) of the glass block covers a same surface area with respect to each of the first and second optical components. Therefore, a uniform mechanical strength can be achieved with respect to the first and second optical components.

In some implementations, the glass block may include a plurality of micro-channels. For example, the micro-channels may be formed in a surface of the glass block through a mechanical machining process, a chemical etching process, etc. The coupling material may be provided in the micro-channels. The micro-channels may have a triangular shape (e.g., with rounded corners). For example, the micro-channels may have a height which is less than about one micrometer to about less than one hundred micrometers. For example, the micro-channels may have a same height and/or length, however in some implementations the micro-channels may each have different dimensions. In some implementations, the micro-channels may be shaped differently (e.g., half-circular shaped, square shaped, etc.). In some implementations, the micro-channels may be formed on an entirety of a side surface of the glass block. In some implementations, the micro-channels may be formed on a portion of a side surface of the glass block.

In another example implementation, the glass block may be positioned over (above) the first optical component and to the side of (adjacent to) the first optical component and over (above) the second optical component, where the first and second optical components are butt-coupled together in an end-to-end manner. In some implementations, the first optical component and second optical component correspond to silicon chips. In some implementations, the first optical component may correspond to an optical sub-assembly and the second optical component may correspond to a laser array chip.

In this example, the coupling material may be provided between a first side of the first optical component and the glass block, between a second side of the first optical component and the glass block, and between a first side of the second optical component and the glass block. For example, the second side of the first optical component may be perpendicular to the first side of the second optical component. For example, micro-channels with the coupling material provided therein may be formed on a first side of the glass block which faces the first side of the first optical component, on a second side of the glass block which faces the first side of the second optical component, and on a third side of the glass block which faces the second side of the first optical component. The first and second optical components may have different heights (thicknesses). The glass block may have a stepped shape and may provide for a bonding interface area that is increased over a bonding interface area between the first and second optical components.

In some implementations, the first optical component may include a first plurality of waveguides (e.g., four-channel waveguides) provided near a center (central portion) of the first optical component. The vertical height of the first optical component may be about a few hundred micrometers to about a couple millimeters. In some implementations, the second optical component may include a second plurality of waveguides (e.g., four-channel waveguides) provided near a particular surface or portion (e.g., an upper surface or upper portion) of the second optical component (e.g., about a few micrometers from the particular surface of the second optical component).

In a further example implementation, the glass block may be positioned over (above) the first optical component and to the side of (adjacent to) the first optical component and over (above) the second optical component, where the first and second optical components are butt-coupled together in an end-to-end manner, however with a reduced overlapping area. In some implementations, the first optical component and second optical component correspond to silicon chips. In some implementations, the first optical component may correspond to an optical sub-assembly and the second optical component may correspond to a laser array chip.

In this example, the coupling material may be provided between a first side of the first optical component and the glass block and between a first side of the second optical component and the glass block. For example, the first side of the first optical component may be perpendicular to the first side of the second optical component. For example, micro-channels with the coupling material provided therein may be formed on a first side of the glass block which faces the first side of the first optical component and on a second side of the glass block which faces the first side of the second optical component. The first and second optical components may have different heights (thicknesses). For example, the first optical component may include a first active surface which is provided at a second side of the first optical component (e.g., a lower side) and the second optical component may include a second active surface which is provided at the first side of the second optical component (e.g., an upper side). The glass block may provide for a bonding interface area that is increased over a bonding interface area between the first and second optical components (e.g., an increase from a few micrometers to hundreds of micrometers or more), thereby improving a mechanical integrity.

In another example implementation, the glass block may be positioned to the side of (adjacent to) the first optical component and over (above) the second optical component, where the first and second optical components are butt-coupled together in an end-to-end manner. In some implementations, the first optical component and second optical component correspond to silicon chips. In some implementations, the first optical component may correspond to an optical sub-assembly and the second optical component may correspond to a laser array chip.

In this example, the coupling material may be provided between a first side of the first optical component and the glass block and between a first side of the second optical component and the glass block. For example, the first side of the first optical component may be perpendicular to the first side of the second optical component. For example, micro-channels with the coupling material provided therein may be formed on a first side of the glass block which faces the first side of the first optical component and on a second side of the glass block which faces the first side of the second optical component.

In some implementations, when the first optical component is the optical sub-assembly, the waveguides (e.g., four-channel waveguides) associated with the optical sub-assembly may be provided near a center (central portion) of the optical sub-assembly. The vertical height of the optical sub-assembly may be about a few hundred micrometers to about a couple millimeters. In some implementations, when the second optical component is the laser array chip, the waveguides (e.g., four-channel waveguides) associated with the laser array chip may be provided near a particular surface or portion of one side (e.g., an upper side, an upper portion, etc.) of the laser array chip (e.g., about a few micrometers from the upper surface of the laser array chip). The laser array chip may have the same waveguide pitch as the optical sub-assembly.

According to examples of the disclosure, a method for manufacturing a semiconductor-based LIDAR sensor system for a vehicle includes providing a first optical component formed of a first semiconductor material; providing a second optical component formed of a second semiconductor material; providing a glass block on a first side of the first optical component and a first side of the second optical component; providing a liquid coupling material between the first side of the first optical component and the glass block and between the first side of the second optical component and the glass block; and curing the liquid coupling material by exposing a first interface between the first side of the first optical component and the glass block and a second interface between the first side of the second optical component and the glass block, to a light source.

For example, the method may include providing the liquid coupling material between the first side of the first optical component and the glass block and between the first side of the second optical component and the glass block by dispensing a liquid coupling material (e.g., a liquid ultraviolet material) at one or two sides of the glass block.

When the glass block includes the micro-channels, under the capillary force effect, the liquid coupling material (e.g., the liquid ultraviolet material, liquid ultraviolet polymer material) can naturally flow into the micro-channels from one side to another side, as well as fill the narrow gap (about a couple micrometers or less) within the two optical components (e.g., within the two silicon chips). After the liquid UV material fills the T-shape triangle surface and alignment accuracy is achieved, the method may include turning on (activating) a UV light positioned adjacent to the upper side of the glass block. The UV light can be transmitted through the glass block to cure the liquid UV coupling material within the micro-channels and the glass block to optical component interface. The disclosed curing method provides good mechanical strength to hold the first and second optical components together. The UV coupling polymer material may be formed to be cured via a UV curing process and a thermal curing process. Thus, in some implementations, a moderate thermal curing can be performed after the UV curing, to fully cure the UV coupling material between the two optical components (e.g., the two silicon chips).

In some implementations, the glass block may include a center through-hole with a diameter of about a couple hundred micrometers or up to about a couple millimeters. This center through-hole can be configured as a reservoir of the liquid UV material, and the method may include dispensing liquid UV droplets from an inlet of the through-hole. The hole reservoir design can improve the UV coupling material dispensing process repeatability significantly.

The glass block can include the plurality of micro-channels which are applied on one or more sides of the glass block. The use of micro-channels can help control and guide the UV liquid coupling material to flow through the capillary force effect.

In some implementations, the method includes turning on a light source (e.g., an UV light) after the UV liquid coupling material flows to fill the T-shaped region to cure the UV liquid coupling material. For example, the UV curing process may be performed with respect to an upper part of the T-shaped region after the first and second optical components are properly aligned with one another (e.g., after active alignment). The method may include performing a thermal curing process after the UV curing process to cure the liquid UV material within the micro-gap between the first and second optical components (e.g., between the optical sub-assembly and laser array chip).

In some implementations, the glass block can include the micro-channels and/or the through-hole. In an example implementation, the glass block has at least three sides with micro-channels. When the UV liquid coupling material is dispensed on a first surface (e.g., an upper or top surface) of the glass block, the micro-channels on the first surface can be configured to guide the flow of the liquid coupling material to micro-channels on a second surface (e.g., a side surface) to guide the flow of the liquid coupling material in a particular direction (e.g., downward) and to micro-channels on a third surface (e.g., a bottom or lower surface) of the glass block.

The disclosed optical system and method can be implemented to ensure that the first and second optical components are securely and accurately coupled together, thereby improving the structural integrity of the optical components of the optical system. Further, according to the optical system and method an alignment of waveguides between optical components can be improved compared to previous methods.

Example aspects of the disclosure are directed to LIDAR systems for autonomous vehicles. As further described herein, the LIDAR systems can be used by various devices and platforms (e.g., robotic platforms, etc.) to improve the ability of the devices and platforms to perceive their environment and perform functions in response thereto (e.g., autonomously navigating through the environment).

An autonomous vehicle (AV) can include a LIDAR system to assist the AV in perceiving its environment and navigating its environment. The LIDAR system can include a transceiver having a transmitter and receiver. The transmitter can condition a light beam (e.g., a laser beam) to be emitted by the LIDAR system into its environment. Similarly, the receiver can provide for receiving the light beam after it is emitted into the environment of the LIDAR system and reflected by objects in the environment. The receiver can provide the received beam to downstream components of the LIDAR system for processing, which can provide for the AV to perceive its environment. Because of the correlation between the transmitted beam and received beam, the transmitter and receiver may generally be placed in a tightly controlled positional relationship. For instance, the portion of the transmitter that emits the beam can be positioned near the portion of the receiver that receives the beam. In addition, some LIDAR systems such as coherent LIDAR systems can utilize a reference signal, such as a local oscillator (LO) signal, which passes from the transmitter to receiver without being emitted into the environment of the LIDAR system. For instance, this reference signal may be combined with the received beam to denoise or otherwise process the received beam to extract useful information. For instance, the LIDAR system can determine a distance to the object and/or velocity of the object based on the reflected beam.

The disclosure provides an improved LIDAR system, such as a coherent LIDAR system, which includes components which are properly aligned, coupled together, or positioned according to specification or tolerance requirements.

A coupling system and a LIDAR system according to the disclosure can provide numerous technical effects and benefits. For example, a coupling method implemented by a coupling system as described herein can ensure that semiconductor optical devices implemented in a LIDAR system operate (function) according to specifications and are positioned within a LIDAR system (e.g. LIDAR sensor system) according to design or specification requirements.

For instance, the LIDAR systems manufactured according to the disclosure can provide improved accuracy of object detections through properly aligned or coupled components (e.g., properly aligned semiconductor optical devices). In addition, when a plurality of semiconductor optical devices are provided, the semiconductor optical devices can be coupled together with respect to one another according to the methods described herein, thereby improving the quality of the LIDAR system (e.g., LIDAR sensor system). In this manner, LIDAR systems according to the disclosure can provide improved performance compared to some existing LIDAR systems.

Example aspects of the disclosure provide an example Light Detection and Ranging (LIDAR) sensor system. The example LIDAR sensor system includes an optical system, including: a first optical component formed of a first semiconductor material; a second optical component formed of a second semiconductor material; a glass block disposed on a first side of the first optical component and a first side of the second optical component, the glass block including a plurality of micro-channels; and a coupling material, disposed in the plurality of micro-channels, between the first side of the first optical component and the glass block and between the first side of the second optical component and the glass block.

In some implementations, the coupling material is further disposed between a second side of the first optical component and a second side of the second optical component.

In some implementations, the coupling material is an ultraviolet polymer material.

In some implementations, the first side of the first optical component is perpendicular to the first side of the second optical component.

In some implementations, the coupling material is disposed between a second side of the first optical component and at least two sides of the second optical component.

In some implementations, the first optical component includes a first active surface disposed at a second side of the first optical component, the second optical component includes a second active surface disposed at the first side of the second optical component, and the first active surface includes a first plurality of waveguides which are aligned with a second plurality of waveguides included in the second active surface.

In some implementations, an area of the glass block disposed on the first side of the first optical component is substantially the same as an area of the glass block disposed on the first side of the second optical component.

In some implementations, one or more sides of the glass block face at least one of the first side of the first optical component and the first side of the second optical component, and the one or more sides of the glass block comprise the plurality of micro-channels.

In some implementations, the plurality of micro-channels are disposed on a first side the glass block, and the first side of the glass block faces the first side of the first optical component and the first side of the second optical component.

In some implementations, the glass block comprises the plurality of micro-channels on at least three sides of the glass block.

In some implementations, the glass block includes a through-hole which extends from a first side of the glass block to a second side of the glass block, the second side of the glass block faces the first side of the first optical component and the first side of the second optical component, and at least the second side of the glass block comprises the plurality of micro-channels.

In some implementations, a thickness of the coupling material disposed between the first side of the first optical component and the glass block is less than one micrometer.

Example aspects of the disclosure provide an example autonomous vehicle (AV) control system for a vehicle. The example AV control system for the vehicle includes one or more processors and the example LIDAR sensor system described herein.

Example aspects of the disclosure provide an example autonomous vehicle (AV). The example AV includes an autonomous vehicle control system, the autonomous vehicle control system comprising one or more processors and a Light Detection and Ranging (LIDAR) sensor system, the LIDAR sensor system comprising: a light source configured to emit a beam to be directed toward an object in an environment of the autonomous vehicle; a first optical component formed of a first semiconductor material; a second optical component formed of a second semiconductor material to receive the beam directed by the first optical component; a glass block disposed on a first side of the first optical component and a first side of the second optical component, the glass block comprising a plurality of micro-channels; and a coupling material, disposed in the plurality of micro-channels, between the first side of the first optical component and the glass block and between the first side of the second optical component and the glass block; a receiver configured to receive a reflected beam from the object and determine an object detection associated with the object; and an autonomous vehicle controller configured to control the autonomous vehicle based on the object detection associated with the object.

Example aspects of the disclosure provide an example method for manufacturing a semiconductor-based LIDAR sensor system for a vehicle. The example method includes providing a first optical component formed of a first semiconductor material; providing a second optical component formed of a second semiconductor material; providing a glass block comprising a plurality of micro-channels, the glass block being disposed on a first side of the first optical component and a first side of the second optical component; providing a liquid coupling material in the plurality of micro-channels, the liquid coupling material being provided between the first side of the first optical component and the glass block and between the first side of the second optical component and the glass block; and curing the liquid coupling material by exposing a first interface between the first side of the first optical component and the glass block and a second interface between the first side of the second optical component and the glass block, to a light source.

In some implementations, the light source is an ultraviolet light source, and curing the liquid coupling material comprises exposing the first interface between the first side of the first optical component and the glass block and the second interface between the first side of the second optical component and the glass block, to the ultraviolet light source, and the method further comprises thermally curing the liquid coupling material after exposing the first interface between the first side of the first optical component and the glass block and the second interface between the first side of the second optical component and the glass block, to the ultraviolet light source.

In some implementations, providing the liquid coupling material further comprises providing the liquid coupling material through a through-hole which extends from a first side of the glass block to a second side of the glass block.

In some implementations, the plurality of micro-channels include a first plurality of micro-channels provided on a first side among a plurality of sides of the glass block and a second plurality of micro-channels provided on a second side among the plurality of sides of the glass block, the glass block includes at least one hole disposed at the first side among the plurality of sides of the glass block, and providing the liquid coupling material comprises providing the liquid coupling material through the at least one hole, guiding the liquid coupling material from the first plurality of micro-channels to the second plurality of micro-channels, and guiding the liquid coupling material from the second plurality of micro-channels to a third plurality of micro-channels on a third side among the plurality of sides of the glass block, wherein the third side among the plurality of sides of the glass block faces at least one of the first side of the of the first optical component and the first side of the second optical component.

In some implementations, the plurality of micro-channels are disposed on a first side the glass block and the first side of the glass block faces the first side of the first optical component and the first side of the second optical component, and providing the liquid coupling material comprises guiding the liquid coupling material via the plurality of micro-channels in a direction from the first side of the first optical component to the first side of the second optical component.

In some implementations, the plurality of micro-channels include a first plurality of micro-channels disposed on a first side the glass block and a second plurality of micro-channels disposed on a second side of the glass block, the first side of the glass block faces the first side of the first optical component and the second side of the glass block faces the first side of the second optical component, and providing the liquid coupling material comprises guiding the liquid coupling material to flow in a first direction along the first plurality of micro-channels parallel to the first side of the first optical component to flow in a second direction along the second plurality of micro-channels parallel to the first side of the second optical component.

Other example aspects of the disclosure are directed to other systems, methods, vehicles, apparatuses, tangible non-transitory computer-readable media, and devices for motion prediction and/or operation of a device including a LIDAR system having a LIDAR module according to example aspects of the disclosure.

These and other features, aspects and advantages of various implementations of the disclosure will become better understood with reference to the following description and appended claims. The accompanying drawings, which are incorporated in and constitute a part of this specification, illustrate implementations of the disclosure and, together with the description, serve to explain the related principles.

### BRIEF DESCRIPTION OF THE DRAWINGS

FIG. 1 depicts a block diagram of an example system according to some implementations of the disclosure.

FIG. 2 depicts a block diagram of an example LIDAR system according to some implementations of the disclosure.

FIG. 3A depicts an example optical system for a LIDAR system according to some implementations of the disclosure.

FIG. 3B depicts another example optical system for a LIDAR system according to some implementations of the disclosure.

FIG. 4A depicts an example optical system for a LIDAR system according to some implementations of the disclosure.

FIG. 4B depicts an example optical system for a LIDAR system according to some implementations of the disclosure.

FIG. 4C depicts an example optical system for a LIDAR system according to some implementations of the disclosure.

FIGS. 5A-5D illustrate example aspects of the micro-channels which may be provided to a glass block, according to some implementations of the disclosure.

FIG. 6 depicts an example optical system for a LIDAR system according to some implementations of the disclosure.

FIGS. 7A-7B are examples of glass blocks having holes for facilitating the dispensing of liquid coupling material to micro-channels of the glass block, according to some implementations of the disclosure.

FIGS. 8-9 illustrate flow diagrams of example, non-limiting computer-implemented methods, according to one or more example embodiments of the disclosure.

### DETAILED DESCRIPTION

The following describes the technology of this disclosure within the context of a LIDAR system and an autonomous vehicle for example purposes only. As described herein, the technology is not limited to an autonomous vehicle and can be implemented within other robotic and computing systems as well as various devices. For example, the systems and methods disclosed herein can be implemented in a variety of ways including, but not limited to, a computer-implemented method, an autonomous vehicle system, an autonomous vehicle control system, a robotic platform system, a general robotic device control system, a computing device, etc.

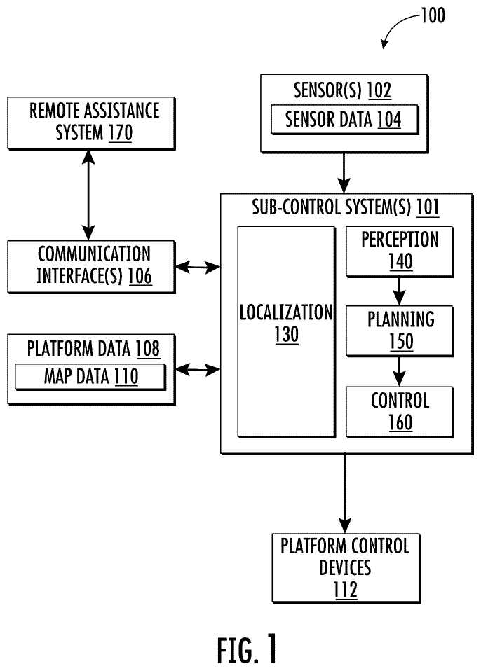

With reference to FIGS. 1-9, example implementations of the disclosure are discussed in further detail. FIG. 1 depicts a block diagram of an example autonomous vehicle control system 100 for an autonomous vehicle according to some implementations of the disclosure. The autonomous vehicle control system 100 can be implemented by a computing system of an autonomous vehicle). The autonomous vehicle control system 100 can include one or more sub-control systems 101 that operate to obtain inputs from sensor(s) 102 or other input devices of the autonomous vehicle control system 100. In some implementations, the sub-control system(s) 101 can additionally obtain platform data 108 (e.g., map data 110) from local or remote storage. The sub-control system(s) 101 can generate control outputs for controlling the autonomous vehicle (e.g., through platform control devices 112, etc.) based on sensor data 104, map data 110, or other data. The sub-control system 101 may include different subsystems for performing various autonomy operations. The subsystems may include a localization system 130, a perception system 140, a planning system 150, and a control system 160. The localization system 130 can determine the location of the autonomous vehicle within its environment; the perception system 140 can detect, classify, and track objects and actors in the environment; the planning system 150 can determine a trajectory for the autonomous vehicle; and the control system 160 can translate the trajectory into vehicle controls for controlling the autonomous vehicle. The sub-control system(s) 101 can be implemented by one or more onboard computing system(s). The subsystems can include one or more processors and one or more memory devices. The one or more memory devices can store instructions executable by the one or more processors to cause the one or more processors to perform operations or functions associated with the subsystems. The computing resources of the sub-control system(s) 101 can be shared among its subsystems, or a subsystem can have a set of dedicated computing resources.

In some implementations, the autonomous vehicle control system 100 can be implemented for or by an autonomous vehicle (e.g., a ground-based autonomous vehicle). The autonomous vehicle control system 100 can perform various processing techniques on inputs (e.g., the sensor data 104, the map data 110) to perceive and understand the vehicle's surrounding environment and generate an appropriate set of control outputs to implement a vehicle motion plan (e.g., including one or more trajectories) for traversing the vehicle's surrounding environment. In some implementations, an autonomous vehicle implementing the autonomous vehicle control system 100 can drive, navigate, operate, etc. with minimal or no interaction from a human operator (e.g., driver, pilot, etc.).

In some implementations, the autonomous vehicle can be configured to operate in a plurality of operating modes. For instance, the autonomous vehicle can be configured to operate in a fully autonomous (e.g., self-driving, etc.) operating mode in which the autonomous platform is controllable without user input (e.g., can drive and navigate with no input from a human operator present in the autonomous vehicle or remote from the autonomous vehicle, etc.). The autonomous vehicle can operate in a semi-autonomous operating mode in which the autonomous vehicle can operate with some input from a human operator present in the autonomous vehicle (or a human operator that is remote from the autonomous platform). In some implementations, the autonomous vehicle can enter into a manual operating mode in which the autonomous vehicle is fully controllable by a human operator (e.g., human driver, etc.) and can be prohibited or disabled (e.g., temporary, permanently, etc.) from performing autonomous navigation (e.g., autonomous driving, etc.). The autonomous vehicle can be configured to operate in other modes such as, for example, park or sleep modes (e.g., for use between tasks such as waiting to provide a trip/service, recharging, etc.). In some implementations, the autonomous vehicle can implement vehicle operating assistance technology (e.g., collision mitigation system, power assist steering, etc.), for example, to help assist the human operator of the autonomous platform (e.g., while in a manual mode, etc.).

The autonomous vehicle control system 100 can be located onboard (e.g., on or within) an autonomous vehicle and can be configured to operate the autonomous vehicle in various environments. The environment may be a real-world environment or a simulated environment. In some implementations, one or more simulation computing devices can simulate one or more of: the sensors 102, the sensor data 104, communication interface(s) 106, the platform data 108, or the platform control devices 112 for simulating operation of the autonomous vehicle control system 100.

In some implementations, the sub-control system(s) 101 can communicate with one or more networks or other systems with communication interface(s) 106. The communication interface(s) 106 can include any suitable components for interfacing with one or more network(s), including, for example, transmitters, receivers, ports, controllers, antennas, or other suitable components that can help facilitate communication. In some implementations, the communication interface(s) 106 can include a plurality of components (e.g., antennas, transmitters, or receivers, etc.) that allow it to implement and utilize various communication techniques (e.g., multiple-input, multiple-output (MIMO) technology, etc.).

In some implementations, the sub-control system(s) 101 can use the communication interface(s) 106 to communicate with one or more computing devices that are remote from the autonomous vehicle over one or more network(s). For instance, in some examples, one or more inputs, data, or functionalities of the sub-control system(s) 101 can be supplemented or substituted by a remote system communicating over the communication interface(s) 106. For instance, in some implementations, the map data 110 can be downloaded over a network to a remote system using the communication interface(s) 106. In some examples, one or more of the localization system 130, the perception system 140, the planning system 150, or the control system 160 can be updated, influenced, nudged, communicated with, etc. by a remote system for assistance, maintenance, situational response override, management, etc.

The sensor(s) 102 can be located onboard the autonomous platform. In some implementations, the sensor(s) 102 can include one or more types of sensor(s). For instance, one or more sensors can include image capturing device(s) (e.g., visible spectrum cameras, infrared cameras, etc.). Additionally, or alternatively, the sensor(s) 102 can include one or more depth capturing device(s). For example, the sensor(s) 102 can include one or more LIDAR sensor(s) or Radio Detection and Ranging (RADAR) sensor(s). The sensor(s) 102 can be configured to generate point data descriptive of at least a portion of a three-hundred-and-sixty-degree view of the surrounding environment. The point data can be point cloud data (e.g., three-dimensional LIDAR point cloud data, RADAR point cloud data). In some implementations, one or more of the sensor(s) 102 for capturing depth information can be fixed to a rotational device in order to rotate the sensor(s) 102 about an axis. The sensor(s) 102 can be rotated about the axis while capturing data in interval sector packets descriptive of different portions of a three-hundred-and-sixty-degree view of a surrounding environment of the autonomous platform. In some implementations, one or more of the sensor(s) 102 for capturing depth information can be solid state.

The sensor(s) 102 can be configured to capture the sensor data 104 indicating or otherwise being associated with at least a portion of the environment of the autonomous vehicle. The sensor data 104 can include image data (e.g., 2D camera data, video data, etc.), RADAR data, LIDAR data (e.g., 3D point cloud data, etc.), audio data, or other types of data. In some implementations, the sub-control system(s) 101 can obtain input from additional types of sensors, such as inertial measurement units (IMUs), altimeters, inclinometers, odometry devices, location or positioning devices (e.g., GPS, compass), wheel encoders, or other types of sensors. In some implementations, the sub-control system(s) 101 can obtain sensor data 104 associated with particular component(s) or system(s) of the autonomous vehicle. This sensor data 104 can indicate, for example, wheel speed, component temperatures, steering angle, cargo or passenger status, etc. In some implementations, the sub-control system(s) 101 can obtain sensor data 104 associated with ambient conditions, such as environmental or weather conditions. In some implementations, the sensor data 104 can include multi-modal sensor data. The multi-modal sensor data can be obtained by at least two different types of sensor(s) (e.g., of the sensors 102) and can indicate static and/or dynamic object(s) or actor(s) within an environment of the autonomous vehicle. The multi-modal sensor data can include at least two types of sensor data (e.g., camera and LIDAR data). In some implementations, the autonomous vehicle can utilize the sensor data 104 for sensors that are remote from (e.g., offboard) the autonomous vehicle. This can include for example, sensor data 104 captured by a different autonomous vehicle.

The sub-control system(s) 101 can obtain the map data 110 associated with an environment in which the autonomous vehicle was, is, or will be located. The map data 110 can provide information about an environment or a geographic area. For example, the map data 110 can provide information regarding the identity and location of different travel ways (e.g., roadways, etc.), travel way segments (e.g., road segments, etc.), buildings, or other items or objects (e.g., lampposts, crosswalks, curbs, etc.); the location and directions of boundaries or boundary markings (e.g., the location and direction of traffic lanes, parking lanes, turning lanes, bicycle lanes, other lanes, etc.); traffic control data (e.g., the location and instructions of signage, traffic lights, other traffic control devices, etc.); obstruction information (e.g., temporary or permanent blockages, etc.); event data (e.g., road closures/traffic rule alterations due to parades, concerts, sporting events, etc.); nominal vehicle path data (e.g., indicating an ideal vehicle path such as along the center of a certain lane, etc.); or any other map data that provides information that assists an autonomous vehicle in understanding its surrounding environment and its relationship thereto. In some implementations, the map data 110 can include high-definition map information. Additionally, or alternatively, the map data 110 can include sparse map data (e.g., lane graphs, etc.). In some implementations, the sensor data 104 can be fused with or used to update the map data 110 in real time.

The sub-control system(s) 101 can include the localization system 130, which can provide an autonomous vehicle with an understanding of its location and orientation in an environment. In some examples, the localization system 130 can support one or more other subsystems of the sub-control system(s) 101, such as by providing a unified local reference frame for performing, e.g., perception operations, planning operations, or control operations.

In some implementations, the localization system 130 can determine the current position of the autonomous vehicle. A current position can include a global position (e.g., respecting a georeferenced anchor, etc.) or relative position (e.g., respecting objects in the environment, etc.). The localization system 130 can generally include or interface with any device or circuitry for analyzing a position or change in position of an autonomous vehicle. For example, the localization system 130 can determine position by using one or more of: inertial sensors (e.g., inertial measurement unit(s), etc.), a satellite positioning system, radio receivers, networking devices (e.g., based on IP address, etc.), triangulation or proximity to network access points or other network components (e.g., cellular towers, Wi-Fi access points, etc.), or other suitable techniques. The position of the autonomous vehicle can be used by various subsystems of the sub-control system(s) 101 or provided to a remote computing system (e.g., using the communication interface(s) 106).

In some implementations, the localization system 130 can register relative positions of elements of a surrounding environment of the autonomous vehicle with recorded positions in the map data 110. For instance, the localization system 130 can process the sensor data 104 (e.g., LIDAR data, RADAR data, camera data, etc.) for aligning or otherwise registering to a map of the surrounding environment (e.g., from the map data 110) to understand the autonomous vehicle's position within that environment. Accordingly, in some implementations, the autonomous vehicle can identify its position within the surrounding environment (e.g., across six axes, etc.) based on a search over the map data 110. In some implementations, given an initial location, the localization system 130 can update the autonomous vehicle's location with incremental re-alignment based on recorded or estimated deviations from the initial location. In some implementations, a position can be registered directly within the map data 110.

In some implementations, the map data 110 can include a large volume of data subdivided into geographic tiles, such that a desired region of a map stored in the map data 110 can be reconstructed from one or more tiles. For instance, a plurality of tiles selected from the map data 110 can be stitched together by the sub-control system 101 based on a position obtained by the localization system 130 (e.g., a number of tiles selected in the vicinity of the position).

In some implementations, the localization system 130 can determine positions (e.g., relative or absolute) of one or more attachments or accessories for an autonomous vehicle. For instance, an autonomous vehicle can be associated with a cargo platform, and the localization system 130 can provide positions of one or more points on the cargo platform. For example, a cargo platform can include a trailer or other device towed or otherwise attached to or manipulated by an autonomous vehicle, and the localization system 130 can provide for data describing the position (e.g., absolute, relative, etc.) of the autonomous vehicle as well as the cargo platform. Such information can be obtained by the other autonomy systems to help operate the autonomous vehicle.

The sub-control system(s) 101 can include the perception system 140, which can allow an autonomous platform to detect, classify, and track objects and actors in its environment. Environmental features or objects perceived within an environment can be those within the field of view of the sensor(s) 102 or predicted to be occluded from the sensor(s) 102. This can include object(s) not in motion or not predicted to move (static objects) or object(s) in motion or predicted to be in motion (dynamic objects/actors).

The perception system 140 can determine one or more states (e.g., current or past state(s), etc.) of one or more objects that are within the surrounding environment of an autonomous vehicle. For example, state(s) can describe (e.g., for a given time, time period, etc.) an estimate of an object's current or past location (also referred to as position); current or past speed/velocity; current or past acceleration; current or past heading; current or past orientation; size/footprint (e.g., as represented by a bounding shape, object highlighting, etc.); classification (e.g., pedestrian class vs. vehicle class vs. bicycle class, etc.); the uncertainties associated therewith; or other state information. In some implementations, the perception system 140 can determine the state(s) using one or more algorithms or machine-learned models configured to identify/classify objects based on inputs from the sensor(s) 102. The perception system can use different modalities of the sensor data 104 to generate a representation of the environment to be processed by the one or more algorithms or machine-learned models. In some implementations, state(s) for one or more identified or unidentified objects can be maintained and updated over time as the autonomous vehicle continues to perceive or interact with the objects (e.g., maneuver with or around, yield to, etc.). In this manner, the perception system 140 can provide an understanding about a current state of an environment (e.g., including the objects therein, etc.) informed by a record of prior states of the environment (e.g., including movement histories for the objects therein). Such information can be helpful as the autonomous vehicle plans its motion through the environment.

The sub-control system(s) 101 can include the planning system 150, which can be configured to determine how the autonomous platform is to interact with and move within its environment. The planning system 150 can determine one or more motion plans for an autonomous platform. A motion plan can include one or more trajectories (e.g., motion trajectories) that indicate a path for an autonomous vehicle to follow. A trajectory can be of a certain length or time range. The length or time range can be defined by the computational planning horizon of the planning system 150. A motion trajectory can be defined by one or more waypoints (with associated coordinates). The waypoint(s) can be future location(s) for the autonomous platform. The motion plans can be continuously generated, updated, and considered by the planning system 150.

The planning system 150 can determine a strategy for the autonomous platform. A strategy may be a set of discrete decisions (e.g., yield to actor, reverse yield to actor, merge, lane change) that the autonomous platform makes. The strategy may be selected from a plurality of potential strategies. The selected strategy may be a lowest cost strategy as determined by one or more cost functions. The cost functions may, for example, evaluate the probability of a collision with another actor or object.

The planning system 150 can determine a desired trajectory for executing a strategy. For instance, the planning system 150 can obtain one or more trajectories for executing one or more strategies. The planning system 150 can evaluate trajectories or strategies (e.g., with scores, costs, rewards, constraints, etc.) and rank them. For instance, the planning system 150 can use forecasting output(s) that indicate interactions (e.g., proximity, intersections, etc.) between trajectories for the autonomous platform and one or more objects to inform the evaluation of candidate trajectories or strategies for the autonomous platform. In some implementations, the planning system 150 can utilize static cost(s) to evaluate trajectories for the autonomous platform (e.g., “avoid lane boundaries,” “minimize jerk,” etc.). Additionally, or alternatively, the planning system 150 can utilize dynamic cost(s) to evaluate the trajectories or strategies for the autonomous platform based on forecasted outcomes for the current operational scenario (e.g., forecasted trajectories or strategies leading to interactions between actors, forecasted trajectories or strategies leading to interactions between actors and the autonomous platform, etc.). The planning system 150 can rank trajectories based on one or more static costs, one or more dynamic costs, or a combination thereof. The planning system 150 can select a motion plan (and a corresponding trajectory) based on a ranking of a plurality of candidate trajectories. In some implementations, the planning system 150 can select the highest ranked candidate, or a highest ranked feasible candidate.

The planning system 150 can then validate the selected trajectory against one or more constraints before the trajectory is executed by the autonomous platform.

To help with its motion planning decisions, the planning system 150 can be configured to perform a forecasting function. The planning system 150 can forecast future state(s) of the environment. This can include forecasting the future state(s) of other actors in the environment. In some implementations, the planning system 150 can forecast future state(s) based on current or past state(s) (e.g., as developed or maintained by the perception system 140). In some implementations, future state(s) can be or include forecasted trajectories (e.g., positions over time) of the objects in the environment, such as other actors. In some implementations, one or more of the future state(s) can include one or more probabilities associated therewith (e.g., marginal probabilities, conditional probabilities). For example, the one or more probabilities can include one or more probabilities conditioned on the strategy or trajectory options available to the autonomous vehicle. Additionally, or alternatively, the probabilities can include probabilities conditioned on trajectory options available to one or more other actors.

To implement selected motion plan(s), the sub-control system(s) 101 can include a control system 160 (e.g., a vehicle control system). Generally, the control system 160 can provide an interface between the sub-control system(s) 101 and the platform control devices 112 for implementing the strategies and motion plan(s) generated by the planning system 150. For instance, the control system 160 can implement the selected motion plan/trajectory to control the autonomous platform's motion through its environment by following the selected trajectory (e.g., the waypoints included therein). The control system 160 can, for example, translate a motion plan into instructions for the appropriate platform control devices 112 (e.g., acceleration control, brake control, steering control, etc.). By way of example, the control system 160 can translate a selected motion plan into instructions to adjust a steering component (e.g., a steering angle) by a certain number of degrees, apply a certain magnitude of braking force, increase/decrease speed, etc. In some implementations, the control system 160 can communicate with the platform control devices 112 through communication channels including, for example, one or more data buses (e.g., controller area network (CAN), etc.), onboard diagnostics connectors (e.g., OBD-II, etc.), or a combination of wired or wireless communication links. The platform control devices 112 can send or obtain data, messages, signals, etc. to or from the sub-control system(s) 101 (or vice versa) through the communication channel(s).

The sub-control system(s) 101 can receive, through communication interface(s) 106, assistive signal(s) from remote assistance system 170. Remote assistance system 170 can communicate with the sub-control system(s) 101 over a network. In some implementations, the sub-control system(s) 101 can initiate a communication session with the remote assistance system 170. For example, the sub-control system(s) 101 can initiate a session based on or in response to a trigger. In some implementations, the trigger may be an alert, an error signal, a map feature, a request, a location, a traffic condition, a road condition, etc.

After initiating the session, the sub-control system(s) 101 can provide context data to the remote assistance system 170. The context data may include sensor data 104 and state data of the autonomous vehicle. For example, the context data may include a live camera feed from a camera of the autonomous vehicle and the autonomous vehicle's current speed. An operator (e.g., human operator) of the remote assistance system 170 can use the context data to select assistive signals. The assistive signal(s) can provide values or adjustments for various operational parameters or characteristics for the sub-control system(s) 101. For instance, the assistive signal(s) can include way points (e.g., a path around an obstacle, lane change, etc.), velocity or acceleration profiles (e.g., speed limits, etc.), relative motion instructions (e.g., convoy formation, etc.), operational characteristics (e.g., use of auxiliary systems, reduced energy processing modes, etc.), or other signals to assist the sub-control system(s) 101.

The sub-control system(s) 101 can use the assistive signal(s) for input into one or more autonomy subsystems for performing autonomy functions. For instance, the planning system 150 can receive the assistive signal(s) as an input for generating a motion plan. For example, assistive signal(s) can include constraints for generating a motion plan. Additionally or alternatively, assistive signal(s) can include cost or reward adjustments for influencing motion planning by the planning system 150. Additionally, or alternatively, assistive signal(s) can be considered by the sub-control system(s) 101 as suggestive inputs for consideration in addition to other received data (e.g., sensor inputs, etc.).

The sub-control system(s) 101 may be platform agnostic, and the control system 160 can provide control instructions to platform control devices 112 for a variety of different platforms for autonomous movement (e.g., a plurality of different autonomous platforms fitted with autonomous control systems). This can include a variety of different types of autonomous vehicles (e.g., sedans, vans, SUVs, trucks, electric vehicles, combustion power vehicles, etc.) from a variety of different manufacturers/developers that operate in various different environments and, in some implementations, perform one or more vehicle services.

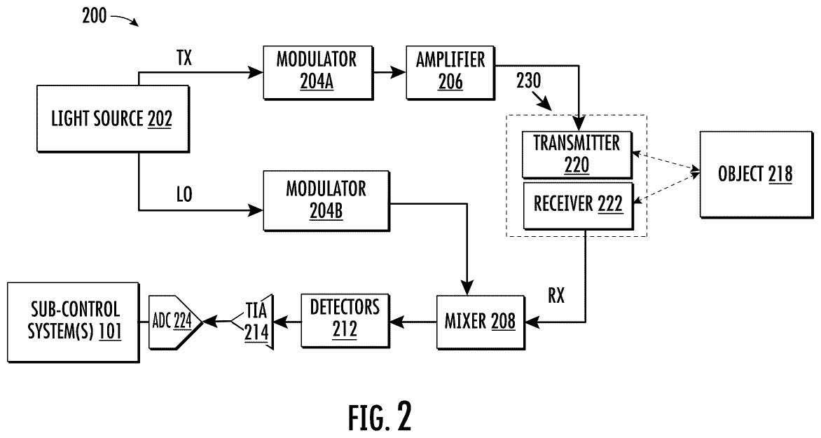

FIG. 2 is a block diagram illustrating an example LIDAR sensor system for autonomous vehicles, according to some implementations. The environment includes a LIDAR system 200 that includes a transmit (Tx) path and a receive (Rx) path. The Tx path includes one or more Tx input/output ports (e.g., channels), and the Rx path includes one or more Rx input/output ports (e.g., channels). In some implementations, a semiconductor substrate and/or semiconductor package may include the Tx path and/or the Rx path. In some implementations, the semiconductor substrate and/or semiconductor package may include at least one of silicon photonics circuitry, programmable logic controller (PLC), or group III-V semiconductor circuitry.

In some implementations, a first semiconductor substrate and/or a first semiconductor package may include the Tx path and a second semiconductor substrate and/or a second semiconductor package may include the Rx path. In some arrangements, the Rx input/output ports and/or the Tx input/output ports may occur (or be formed/disposed/located/placed) along one or more edges of one or more semiconductor substrates and/or semiconductor packages.

The LIDAR system 200 can be coupled to one or more sub-control system(s) 101 (e.g., the sub-control system(s) 101 of FIG. 1). In some implementations, the sub-control system(s) 101 may be coupled to the Rx path via the one or more Rx input/output ports. For instance, the sub-control system(s) 101 can receive LIDAR outputs from the LIDAR system 200. The sub-control system(s) 101 can control a vehicle (e.g., an autonomous vehicle) based on the LIDAR outputs.

The Tx path may include a light source (e.g., laser source) 202, a modulator 204A, a modulator 204B, an amplifier 206, and one or more transmitters 220. The Rx path may include one or more receivers 222, a mixer 208, a detector 212, a transimpedance amplifier (TIA) 214, and one or more analog-to-digital converters (ADCs) 224. Although FIG. 2 shows only a select number of components and only one input/output channel, the LIDAR system 200 may include any number of components and/or input/output channels (in any combination) that are interconnected in any arrangement to facilitate combining multiple functions of a LIDAR system, to support the operation of a vehicle.

The light source 202 may be configured to generate a light signal (or beam) that is derived from (or associated with) a local oscillator (LO) signal. In some implementations, the light signal may have an operating wavelength that is equal to or substantially equal to 1550 nanometers. In some implementations, the light signal may have an operating wavelength that is between 1400 nanometers and 1440 nanometers.

The light source 202 may be configured to provide the light signal to the modulator 204A, which is configured to modulate a phase and/or a frequency of the light signal based on a first radio frequency (RF) signal (e.g., an “RF1” signal) to generate a modulated light signal, such as by Continuous Wave (CW) modulation or quasi-CW modulation. The modulator 204A may be configured to send the modulated light signal to the amplifier 206. The amplifier 206 may be configured to amplify the modulated light signal to generate an amplified light signal for transmission via the one or more transmitters 220. The one or more transmitters 220 may include one or more optical waveguides or antennas. In some implementations, modulator 204A and/or modulator 204B may have a bandwidth between 400 megahertz (MHz) and 1000 (MHZ).

The LIDAR system 200 includes one or more transmitters 220 and one or more receivers 222. The transmitter(s) 220 and/or receiver(s) 222 can be included in a transceiver 230. The transmitter(s) 220 can provide the transmit beam that it receives from the Tx path into an environment within a given field of view toward an object 218. The one or more receivers 222 can receive a received beam reflected from the object 218 and provide the received beam to the mixer 208 of the Rx path. The one or more receivers 222 may include one or more optical waveguides or antennas. In some arrangements, the one or more transceivers 230 may include a monostatic transceiver or a bistatic transceiver.

The light source 202 may be configured to provide the LO signal to the modulator 204B, which is configured to modulate a phase and/or a frequency of the LO signal based on a second RF signal (e.g., an “RF2” signal) to generate a modulated LO signal (e.g., using Continuous Wave (CW) modulation or quasi-CW modulation) and send the modulated LO signal to the mixer 208 of the Rx path. The mixer 208 may be configured to mix (e.g., combine, multiply, etc.) the modulated LO signal with the returned signal to generate a down-converted signal and send the down-converted signal to the detector 212.

In some arrangements, the mixer 208 may be configured to send the modulated LO signal to the detector 212. The detector 212 may be configured to generate an electrical signal based on the down-converted signal and send the electrical signal to the TIA 214. In some arrangements, the detector 212 may be configured to generate an electrical signal based on the down-converted signal and the modulated signal. The TIA 214 may be configured to amplify the electrical signal and send the amplified electrical signal to the sub-control system(s) 101 via the one or more ADCs 224. In some implementations, the TIA 214 may have a peak noise-equivalent power (NEP) that is less than 5 picowatts per square root Hertz (i.e., 5×10-12 Watts per square root Hertz). In some implementations, the TIA 214 may have a gain between 4 kiloohms and 25 kiloohms. In some implementations, detector 212 and/or TIA 214 may have a 3-decibel bandwidth between 80 kilohertz (kHz) and 450 megahertz (MHz).

The sub-control system(s) 101 may be configured to determine a distance to the object 218 and/or measure the velocity of the object 218 based on the one or more electrical signals that it receives from the TIA 214 via the one or more ADCs 224.

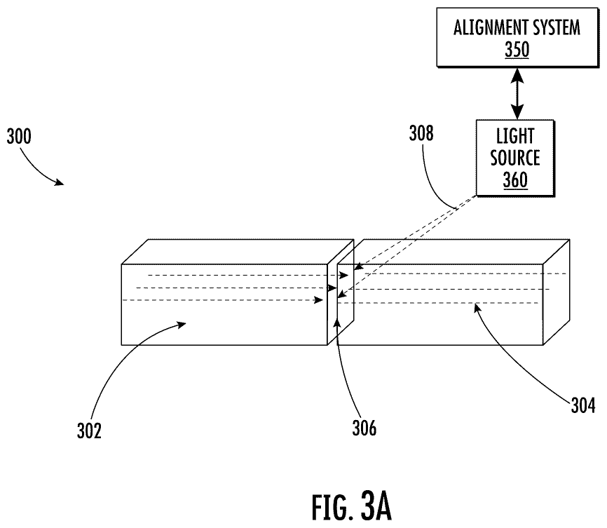

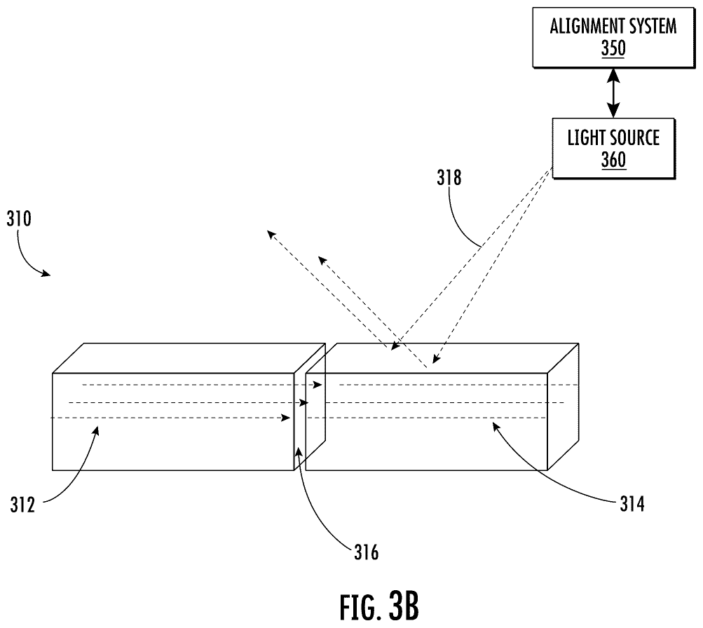

FIG. 3A depicts an optical system 300 of a LIDAR system, according to some implementations of the disclosure. The optical system 300 can be included in a LIDAR system, such as the LIDAR system 200 of FIG. 2 and the like. For example, first and second respective optical components of optical system 300 can correspond to first and second different components of LIDAR system 200 of FIG. 2.

In FIG. 3A, the optical system 300 may include a first optical component 302 and a second optical component 304 that are butt-coupled (or edge-coupled) together. For example, the first optical component 302 may correspond to a silicon chip, for example a silicon chip with three-channel waveguides. The second optical component 304 may correspond to a fiber array unit (also referred to as a fiber-optic array or fiber array). However, the first optical component 302 and the second optical component 304 may correspond to other types of optical devices (e.g., silicon photonic chips, laser array chips, III-IV chips, etc.).

The first optical component 302 and the second optical component 304 may be coupled together, for example, via a coupling material 306 provided between the first optical component 302 and the second optical component 304. The coupling material 306 may have a thickness of about one micrometer or a sub-micrometer thickness (e.g., less than one micrometer). For example, the coupling material 306 may be a polymer material such as an ultraviolet polymer material. For example, the coupling material 306 may be an epoxy such as an ultraviolet epoxy.

In the example of FIG. 3A, the second optical component 304 may be a fiber array unit (FAU). In some implementations, the FAU may include a one or two-dimensional array of optical fibers. A linear (one-dimensional) FAU can be formed by placing individual fibers into V-grooves provided on a solid surface (material). The solid surface may be formed of borosilicate glass and have a low coefficient of thermal expansion (e.g., about 3.3×10⁻⁶ K⁻¹ at 20° C.) which is close to the coefficient of thermal expansion of most semiconductor materials (e.g., such as silicon, GaAs, etc.). Glass is also transparent for a wide range of light, from visible light to UV light and IR light.

An alignment system 350 may be configured to butt-couple the first optical component 302 (e.g., a silicon photonics chip that has multiple channel waveguides) to the second optical component 304 (e.g., the FAU) via the coupling material 306 (e.g., an ultraviolet epoxy, a thermal two-stage cured polymer material, etc.).

The alignment system 350 may be configured to dispense or provide the coupling material 306 (e.g., the ultraviolet epoxy) at the first optical component 302 and/or second optical component 304 waveguide facet surface, and the first optical component 302 and the second optical component 304 can be moved in close contact with each other. The first optical component 302 and the second optical component 304 can be coupled together by fixing the first optical component 302 while holding the second optical component 304 using a jig or fixture. The jig or fixture can be part of an active alignment stage or machine (e.g., part of the alignment system 350) with multiple degrees of freedom in movement (e.g., three to six degrees), to adjust the first optical component 302 and/or the second optical component 304 through one to three axes (e.g., x, y, and z axes) and one to three rotational directions (e.g., yaw, pitch, and roll). For example, the alignment system 350 may be configured to accurately align the one or multiple channel light or waveguides from the first optical component 302 into the waveguides of the second optical component 304. For example, the alignment system 350 may include one or more grippers to securely hold and manipulate optical components during an alignment process.

After aligning the first optical component 302 and/or the second optical component 304 to a specified alignment accuracy (e.g., about two micrometers or less than one micrometer accuracy), the alignment system 350 can be configured to activate or apply a light source 360 (e.g., an ultraviolet light source) to cure the coupling material 306 to mechanically join the first optical component 302 and the second optical component 304. As shown in FIG. 3A, because the FAU is formed of a glass material, the UV light 308 may be transmitted through the second optical component 304 to cure the coupling material 306.

Thermally curing the coupling material 306 may not work in an active alignment butt-coupling process because shrinkage/expansion of the coupling material 306 can cause an alignment shift (misalignment) to occur during the heating/cooling process. In contrast, ultraviolet curing can occur at room temperature, and can result in less misalignment compared to thermal curing. In some implementations, the alignment system 350 may be configured to implement a moderate thermal curing (e.g., at about 100° C.) process with respect to the coupled structure after ultraviolet curing, to further enhance the curing, stabilize the structure, and relieve the structural mechanical internal stress.

FIG. 3B depicts another optical system 310 for a LIDAR system, according to some implementations of the disclosure. The optical system 310 can be included in a LIDAR system, such as the LIDAR system 200 of FIG. 2 and the like.

In FIG. 3B, the optical system 310 may include a first optical component 312 and a second optical component 314 that are butt-coupled (or edge-coupled) together. For example, the first optical component 312 may correspond to a laser array bar having a plurality of channels (e.g., three laser channels). For example, the second optical component 314 may correspond to a silicon chip (e.g., a silicon photonics chip). However, the first optical component 312 and the second optical component 314 may correspond to other types of optical devices.

The first optical component 312 and the second optical component 314 may be coupled together, for example, via a coupling material 316 provided between the first optical component 312 and the second optical component 314. The coupling material 316 may have a thickness of about one micrometer or a sub-micrometer thickness (e.g., less than one micrometer). For example, the coupling material 316 may be a polymer material, for example an ultraviolet polymer material. For example, the coupling material 316 may be an epoxy, for example an ultraviolet epoxy.

In the example of FIG. 3B, the first optical component 312 may be a laser array bar (with three laser channels) and the second optical component 314 may be a silicon photonics chip (e.g., with three waveguides). Unlike glass, optical components/materials (e.g., formed of silicon, GaAs, InP, etc.) absorb ultraviolet (UV) light. That is, the optical components/materials are UV non-transparent. When a polymer material of a minimal thickness (e.g., about two micrometers or less) is provided between the first optical component 312 and the second optical component 314 to couple (e.g., butt-couple) the optical components and the coupling bonding area is relatively large (e.g., multiple millimeter or centimeter square), problems may occur when exposing or curing the polymer material via the light source 360 (e.g., an UV light source). For example, as shown in FIG. 3B, when the second optical component 304 is a semiconductor chip formed of a material such as silicon, GaAs, InP, etc., the UV light from the light source 360 may not reach a shadowed region between the first optical component 312 and the second optical component 314 which are closely placed together, and only a small portion of the outer area of the polymer material (e.g., UV material) may be exposed/cured by the light source 360. Therefore, the polymer material (e.g., UV material) in the shadowed region that was not exposed to the UV light 318 may remain in a liquid state. In such a case, the first optical component 312 and the second optical component 314 may not be mechanically bonded together because the UV material is still mostly liquid. Accordingly, the first optical component 312 and the second optical component 314 may not be sufficiently bonded together, and alignment issues (e.g., alignment accuracy) between the first optical component 312 and the second optical component 314 may be encountered.

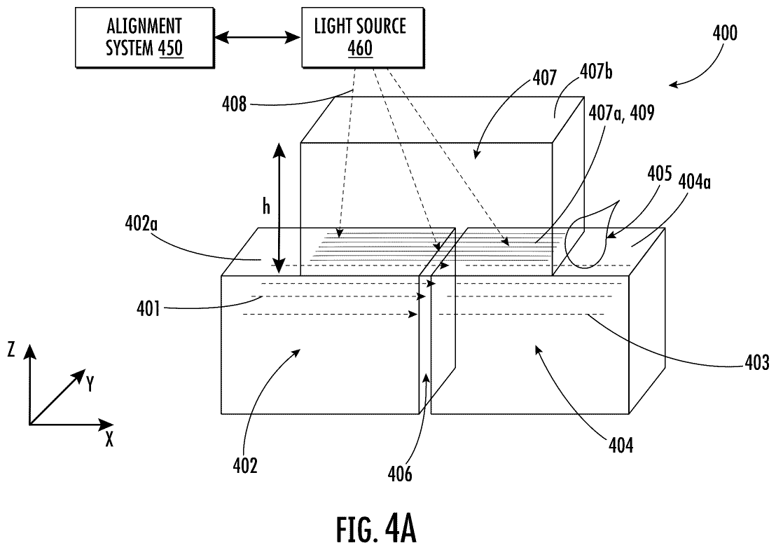

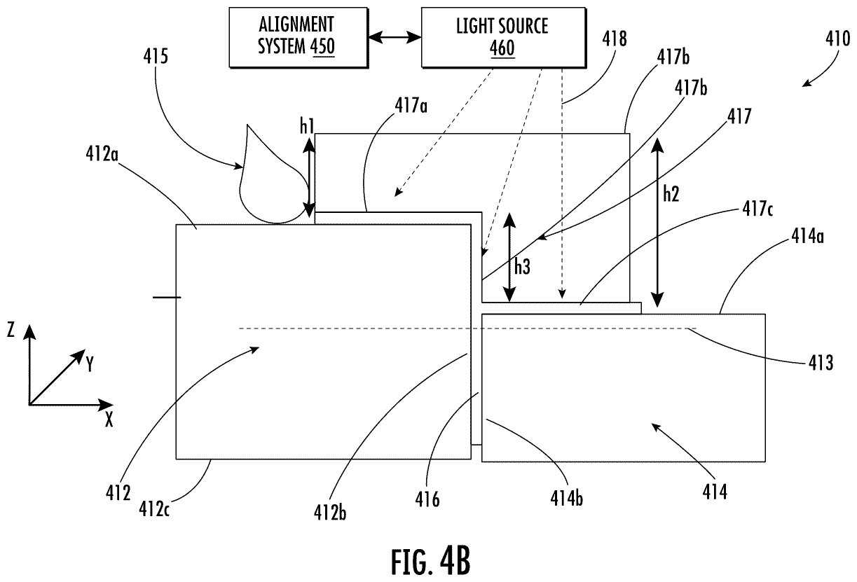

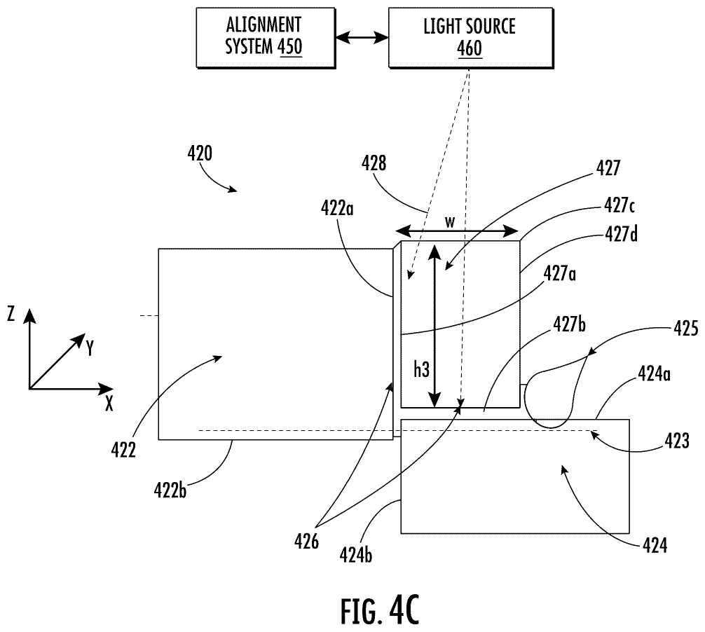

FIG. 4A depicts an example optical system 400 for a LIDAR system, according to some implementations of the disclosure. The optical system 400 can be included in a LIDAR system, such as the LIDAR system 200 of FIG. 2 and the like.

In FIG. 4A, the optical system 400 may include a first optical component 402 and a second optical component 404 that are butt-coupled (or edge-coupled) together. For example, the first optical component 402 may correspond to a silicon chip, for example a silicon chip with a multi-channel waveguide (e.g., a four-channel waveguide). The second optical component 404 may correspond to a silicon chip, for example a silicon chip with a multi-channel waveguide (e.g., a four-channel waveguide). However, the first optical component 402 and the second optical component 404 may correspond to other types of semiconductor optical devices (e.g., silicon photonic chips, III-IV chips, etc.).

In the example of FIG. 4A, a glass block 407 is further provided and implemented to couple the first optical component 402 with the second optical component 404 by providing the coupling material 406 between the first optical component 402 and the glass block 407 and between the second optical component 404 and the glass block 407. The configuration of the glass block 407 can secure the first optical component 402 and the second optical component 404 in a reliable manner with sufficient mechanical strength so that the first optical component 402 and the second optical component 404 are properly aligned.

In some implementations, the first optical component 402 and the second optical component 404 may further be coupled together via the coupling material 406 provided between the first optical component 402 and the second optical component 404. The coupling material 406 may have a thickness of about one micrometer or a sub-micrometer thickness (e.g., less than one micrometer). For example, the coupling material 406 may be a polymer material, for example an ultraviolet polymer material. For example, the coupling material 406 may be an epoxy, for example an ultraviolet epoxy.

In some implementations, the glass block 407 may be positioned over (above in the z-axis direction) the first optical component 402 and the second optical component 404 which are butt-coupled together in an end-to-end manner (e.g., along the x-axis). In some implementations, the first optical component 402 and the second optical component 404 may have the same size in one or more dimensions: the same height (e.g., in the z-axis direction), the same length (e.g., in the x-axis direction), and/or the same width (e.g., in the y-axis direction). However, the first optical component 402 and the second optical component 404 may have different sizes in one or more dimensions. For example, the glass block 407 can be shaped as a rectangular prism (e.g., having a cubic shape). However, the glass block 407 may be shaped differently in other implementations. For example, the glass block 407 may have a length or width of about a few hundred micrometers to about a few tenths of a millimeter. For example, the glass block 407 may have a thickness or height h (e.g., in the vertical or z-axis direction measured from a side of the glass block 407 which faces the first optical component 402 and the second optical component 404 to an opposite side of the glass block 407) of about a few hundred micrometers to about less than one hundred millimeters.

In some implementations, the first optical component 402 includes a first waveguide 401 (e.g., a four-channel waveguide) and the second optical component 404 includes a second waveguide 403 (e.g., a four-channel waveguide). In an example implementation, the waveguides may be positioned at a same height, and for example, at a same distance from a particular surface (e.g., a top or upper surface) of the first optical component 402 and the second optical component 404.

In some implementations, the glass block 407 may be positioned in a symmetrical manner on a first side 402a (e.g., a top or upper surface) of the first optical component 402 and a first side 404a (e.g., a top or upper surface) of the second optical component 404 such that a second side 407a (e.g., a lower or bottom surface) of the glass block 407 covers a same surface area with respect to each of the first optical component 402 and the second optical component 404. Therefore, a uniform mechanical strength can be achieved with respect to the first optical component 402 and the second optical component 404.

In some implementations, the glass block 407 may include a plurality of micro-channels 409 which are provided in the second side 407a. For example, the micro-channels 409 may be formed in the second side 407a of the glass block 407 through a mechanical machining process, a chemical etching process, etc. The alignment system 450 may be configured to dispense the liquid coupling material 405 at the second side 407a, for example, in the micro-channels 409. The liquid coupling material 405 (e.g., liquid UV material) may naturally flow from one side of the micro-channels 409 to another, for example, under the capillary force effect. In some embodiments, the liquid coupling material 405 may fill an area between the first optical component 402 and the second optical component 404 (e.g., where the first optical component 402 is coupled to the second optical component 404, corresponding to the coupling material 406).

After the liquid coupling material 405 is provided and a target alignment accuracy is achieved (e.g., where the first waveguide 401 and the second waveguide 403 are optically aligned), the light source 460 may be configured to apply a light 408 to a second surface 407b (e.g., an upper or top surface) of the glass block 407. The light 408 is transmitted through the glass block 407 to cure the liquid coupling material 405 within the micro-channels 409 and the interface between the glass block 407 and the first optical component 402 and the second optical component 404. This curing process (e.g., a UV curing process) enhances the mechanical strength to hold the first optical component 402 and the second optical component 404 together. In some implementations, the alignment system 450 may be configured to implement a thermal curing process after the ultraviolet light curing, to fully cure the liquid coupling material 405 between the first optical component 402 and the second optical component 404, where the light 408 cannot achieve sufficient curing.

FIG. 4B depicts an example optical system 410 for a LIDAR system according to some implementations of the disclosure. The optical system 410 can be included in a LIDAR system, such as the LIDAR system 200 of FIG. 2 and the like.

In FIG. 4B, the optical system 410 may include a first optical component 412 and a second optical component 414 that are butt-coupled (or edge-coupled) together. For example, the first optical component 412 may correspond to a silicon chip, for example a silicon chip with a multi-channel waveguide (e.g., a four-channel waveguide). For example, the second optical component 414 may correspond to a silicon chip, for example a silicon chip with a multi-channel waveguide (e.g., a four-channel waveguide). However, the first optical component 412 and the second optical component 414 may correspond to other types of semiconductor optical devices (e.g., silicon photonic chips, III-IV chips, etc.).

In the example of FIG. 4B, a glass block 417 is further provided and implemented to couple the first optical component 412 with the second optical component 414 by providing the coupling material 416: between the first optical component 412 and the glass block 417 (e.g., between a first side 417a of the glass block 417 and a first side 412a of the first optical component 412, and between a second side 417b of the glass block 417 and a second side 412b of the first optical component 412); between the second optical component 414 and the glass block 417 (e.g., between a third side 417c of the glass block 417 and a first side 414a of the second optical component 414); and between the first optical component 412 and the second optical component 414 (e.g., between a second side 412b of the first optical component 412 and a second side 414b of the second optical component 414). The configuration of the glass block 417 can secure the first optical component 412 and the second optical component 414 in a reliable manner with sufficient mechanical strength so that the first optical component 412 and the second optical component 414 are properly aligned. For example, the second side 412b of the first optical component 412 may be perpendicular to the first side 414a of the second optical component 414.

In some implementations, the coupling material 416 may have a thickness of about one micrometer or a sub-micrometer thickness (e.g., less than one micrometer). For example, the coupling material 416 may be a polymer material, for example an ultraviolet polymer material. For example, the coupling material 416 may be an epoxy such as an ultraviolet epoxy.

In some implementations, the glass block 417 may be positioned over (above in the z-axis direction) the first optical component 412 and the second optical component 414 which are butt-coupled together in an end-to-end manner (e.g., along the x-axis). In some implementations, the first optical component 412 and the second optical component 414 may have the same size in one or more dimensions: the same height (e.g., in the z-axis direction), the same length (e.g., in the x-axis direction), and/or the same width (e.g., in the y-axis direction). However, the first optical component 412 and the second optical component 414 may have different sizes in one or more dimensions. In the example of FIG. 4B, the glass block 417 has a stepped shape. For example, a height h3 of the step may correspond to a difference in height between the first optical component 412 and the second optical component 414. The stepped shape provides for a bonding interface area that is increased over a bonding interface area between the first optical component 412 and the second optical component 414. In the example of FIG. 4B, the first optical component 412 and the second optical component 414 are shaped differently, with the first optical component 412 having a greater height in the z-axis direction than the second optical component 414. For example, the first optical component 412 may have a height about twice as great as the height of the second optical component 414. For example, the vertical height of the first optical component 412 may be about a few hundred micrometers to about a couple of millimeters.

For example, the glass block 417 may have a length or width (e.g., in the x-axis direction) of about a few hundred micrometers to about a few tenths of a millimeter. For example, the glass block 417 may have a first thickness or first height h1 (e.g., in the vertical or z-axis direction measured from the first side 417a of the glass block 417 which faces the first optical component 412 to an opposite side of the glass block 417) of about a few hundred micrometers to about less than one hundred millimeters. For example, the glass block 417 may have a second thickness or second height h2 (e.g., in the vertical or z-axis direction measured from the third side 417c of the glass block 417 which faces the second optical component 414 to the opposite side of the glass block 417) which is about twice as large as h1.

In some implementations, the first optical component 412 may include one or more first waveguides and the second optical component 414 may include one or more second waveguides. In an example implementation, the waveguides may be positioned at a same height so as to be optically aligned, for example, along axis 413. For example, the one or more first waveguides may be provided at a center or central portion of the first optical component 412 (e.g., about halfway between an upper or top surface of the first side 412a of the first optical component 412 and a lower or bottom surface of a third side 412c of the first optical component 412). For example, the one or more second waveguides may be provided near an upper or top surface of the first side 414a of the second optical component 414 (e.g., about a few micrometers from the upper or top surface of the first side 414a of the second optical component 414).

In some implementations, the glass block 417 may be positioned in a symmetrical manner on the first side 412a of the first optical component 402 and the first side 414a of the second optical component 414 such that the first side 417a of the glass block 417 covers a same upper or top surface area with respect to each of the first optical component 412 and the second optical component 414. Therefore, a uniform mechanical strength can be achieved with respect to the first optical component 412 and the second optical component 414. The second side 417b of the glass block 417 increases the surface area of the glass block 417 which is in contact with the first optical component 412, which is larger in size than the second optical component 414.

In some implementations, the glass block 417 includes a plurality of micro-channels which are provided in one or more of the first side 417a, the second side 417b, and the third side 417c. For example, the micro-channels may be formed through a mechanical machining process, a chemical etching process, etc. For example, the alignment system 450 may be configured to dispense the liquid coupling material 415 at the first side 417a, for example, in the micro-channels. The liquid coupling material 415 (e.g., liquid UV material) may naturally flow from one side of the micro-channels to another, for example, under the capillary force effect. For example, the liquid coupling material 415 may be provided at the interface between the first side 417a of the glass block 417 and the first side 412a of the first optical component 412, at the interface between the second side 417b of the glass block 417 and the second side 412b of the first optical component 412, and at the interface between the third side 417c of the glass block 417 and the first side 414a of the second optical component 414. In some embodiments, the liquid coupling material 415 may also fill an area between the first optical component 412 and the second optical component 414 (e.g., at the interface where the first optical component 412 is coupled to the second optical component 414, corresponding to the coupling material 416).

After the liquid coupling material 415 is provided and a target alignment accuracy is achieved (e.g., where the one or more first waveguides and the one or more second waveguides are optically aligned), the light source 460 may be configured to apply a light 418 to a second side 417b (e.g., an upper or top surface) of the glass block 417. The light 418 is transmitted through the glass block 417 to cure the liquid coupling material 415 within the micro-channels and the interfaces between the glass block 417 and the first optical component 412 and the second optical component 414. This curing process (e.g., a UV curing process) enhances the mechanical strength to hold the first optical component 412 and the second optical component 414 together. In some implementations, the alignment system 450 may be configured to implement a thermal curing process after the ultraviolet light curing, to fully cure the liquid coupling material 415 between the first optical component 412 and the second optical component 414, where the light 418 cannot achieve sufficient curing.

FIG. 4C depicts an example optical system 420 for a LIDAR system according to some implementations of the disclosure. The optical system 420 can be included in a LIDAR system, such as the LIDAR system 200 of FIG. 2 and the like.

In FIG. 4C, the optical system 420 may include a first optical component 422 and a second optical component 424 that are butt-coupled (or edge-coupled) together. For example, the first optical component 422 may correspond to a silicon chip, for example a silicon chip with a multi-channel waveguide (e.g., a four-channel waveguide). For example, the second optical component 424 may correspond to a silicon chip, for example a silicon chip with a multi-channel waveguide (e.g., a four-channel waveguide). However, the first optical component 422 and the second optical component 424 may correspond to other types of semiconductor optical devices (e.g., silicon photonic chips, III-IV chips, etc.).

In the example of FIG. 4C, a glass block 427 is further provided and implemented to couple the first optical component 422 with the second optical component 424 by providing the coupling material 426: between the first optical component 422 and the glass block 427 (e.g., between a first side 427a of the glass block 427 and a first side 422a of the first optical component 422); between the second optical component 424 and the glass block 427 (e.g., between a second side 427b of the glass block 427 and a first side 424a of the second optical component 424); and between the first optical component 422 and the second optical component 424 (e.g., between the first side 422a of the first optical component 422 and a second side 424b of the second optical component 424). The configuration of the glass block 427 can secure the first optical component 422 and the second optical component 424 in a reliable manner with sufficient mechanical strength so that the first optical component 422 and the second optical component 424 are properly aligned. For example, the second side 422b of the first optical component 422 may be perpendicular to the first side 424a of the second optical component 424.

In some implementations, the coupling material 426 may have a thickness of about one micrometer or a sub-micrometer thickness (e.g., less than one micrometer). For example, the coupling material 426 may be a polymer material, for example an ultraviolet polymer material. For example, the coupling material 426 may be an epoxy, for example an ultraviolet epoxy.

In some implementations, the glass block 427 may be positioned adjacent to or next to the first optical component 422 (to the side in the x-axis direction) and over (above in the z-axis direction) the second optical component 424. The first optical component 422 and the second optical component 424 are butt-coupled together in an end-to-end manner (e.g., along the x-axis). In some implementations, the first optical component 422 and the second optical component 424 may have the same size in one or more dimensions: the same height (e.g., in the z-axis direction), the same length (e.g., in the x-axis direction), and/or the same width (e.g., in the y-axis direction). However, the first optical component 422 and the second optical component 424 may have different sizes in one or more dimensions. In the example of FIG. 4C, the glass block 427 has a rectangular prism shape. In the example of FIG. 4C, the first optical component 422 and the second optical component 424 are shaped differently, with the first optical component 422 having a greater height in the z-axis direction than the second optical component 424. For example, a surface area of the first side 422a that is in contact with the glass block 427 is greater than a surface area of the first side 422a that is in contact with the second side 424b of the second optical component 424. For example, the first optical component 422 may have a height about twice as great as the height of the second optical component 424. For example, the vertical height of the first optical component 422 may be about a few hundred micrometers to about a couple of millimeters.

For example, the glass block 427 may have a length or width (e.g., in the x-axis direction) of about a few hundred micrometers to about a few tenths of a millimeter. For example, the glass block 427 may have a first thickness or height h3 (e.g., in the vertical or z-axis direction measured from the second side 427b of the glass block 427 which faces the first side 424a of the second optical component 424 to an opposite side 427c of the glass block 427) of about a few hundred micrometers to about less than one hundred millimeters. For example, the glass block 427 may have a length or width w (e.g., in the horizontal or x-axis direction measured from the first side 427a of the glass block 427 which faces the first side 422a of the first optical component 422 to the opposite side 427d of the glass block 427) which is about half as long as a width of the second optical component 424 in the horizontal or x-axis direction.

In some implementations, the first optical component 422 may include one or more first waveguides and the second optical component 424 may include one or more second waveguides. In an example implementation, the waveguides may be positioned at a same height so as to be optically aligned, for example, along axis 423. For example, the one or more first waveguides may be provided near or at a lower or bottom portion (surface or lower active surface) of the second side 422b of the first optical component 422 (e.g., about a few micrometers from the lower or bottom surface (surface or lower active surface) of the second side 422b of the first optical component 422). For example, the one or more second waveguides may be provided near or at an upper or top portion (surface or upper active surface) of the first side 424a of the second optical component 424 (e.g., about a few micrometers from the upper or top portion (surface or upper active surface) of the first side 424a of the second optical component 424).

In some implementations, the glass block 427 may be positioned in a manner on the first side 422a of the first optical component 402 and the first side 424a of the second optical component 424 such that the first side 427a of the glass block 427 covers a same surface area amount with respect to the first optical component 422 as the second side 427b of the glass block 427 covers the second optical component 424. Therefore, a uniform mechanical strength may be achieved with respect to the first optical component 422 and the second optical component 424. In some implementations, the glass block 427 may be positioned in a manner on the first side 422a of the first optical component 402 and the first side 424a of the second optical component 424 such that the first side 427a of the glass block 427 covers a greater surface area amount with respect to the first optical component 422 compared to a surface area amount covered by the second side 427b of the glass block 427 with respect to the second optical component 424. The first side 427a of the glass block 427 may cover an increased surface area of the first optical component 422 than the second side 427b of the glass block 427 covers the second optical component 424, due to the larger size of the first optical component 422 than the second optical component 424.

In some implementations, the glass block 427 includes a plurality of micro-channels which are provided in one or more of the first side 427a and the second side 427b. For example, the micro-channels may be formed through a mechanical machining process, a chemical etching process, etc. For example, the alignment system 450 may be configured to dispense the liquid coupling material 425 at the first side 427a and/or at the second side 427b, for example, in the micro-channels. The liquid coupling material 425 (e.g., liquid UV material) may naturally flow from one side of the micro-channels to another, for example, under the capillary force effect. For example, the liquid coupling material 425 may be provided at the interface between the first side 427a of the glass block 427 and the first side 422a of the first optical component 422 and at the interface between the second side 427b of the glass block 427 and the first side 424a of the second optical component 424. In some embodiments, the liquid coupling material 425 may also fill an area between the first optical component 422 and the second optical component 424 (e.g., at the interface where the first optical component 422 is coupled to the second optical component 424).

After the liquid coupling material 425 is provided and a target alignment accuracy is achieved (e.g., where the one or more first waveguides and the one or more second waveguides are optically aligned), the light source 460 may be configured to apply a light 428 to the second side 427b (e.g., an upper or top surface) of the glass block 427. The light 428 is transmitted through the glass block 427 to cure the liquid coupling material 425 within the micro-channels and the interfaces between the glass block 427 and the first optical component 422 and the second optical component 424. This curing process (e.g., a UV curing process) enhances the mechanical strength to hold the first optical component 422 and the second optical component 424 together. In some implementations, the alignment system 450 may be configured to implement a thermal curing process after the ultraviolet light curing, to fully cure the liquid coupling material 425 between the first optical component 422 and the second optical component 424, where the light 428 cannot achieve sufficient curing.

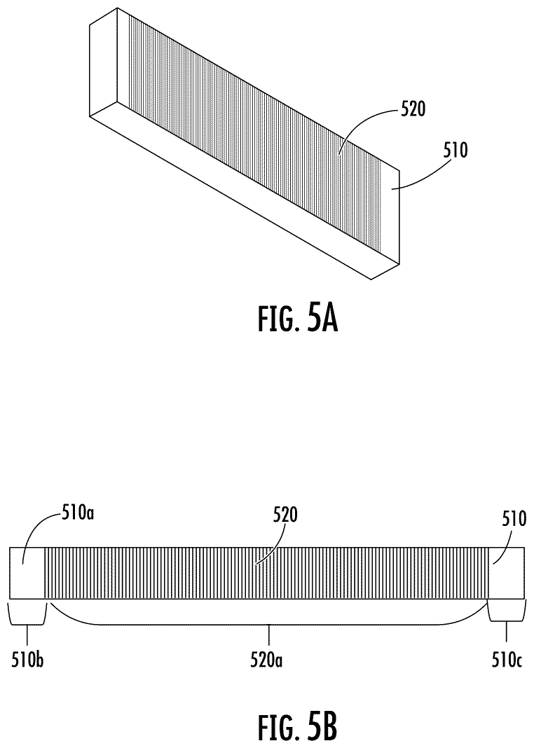

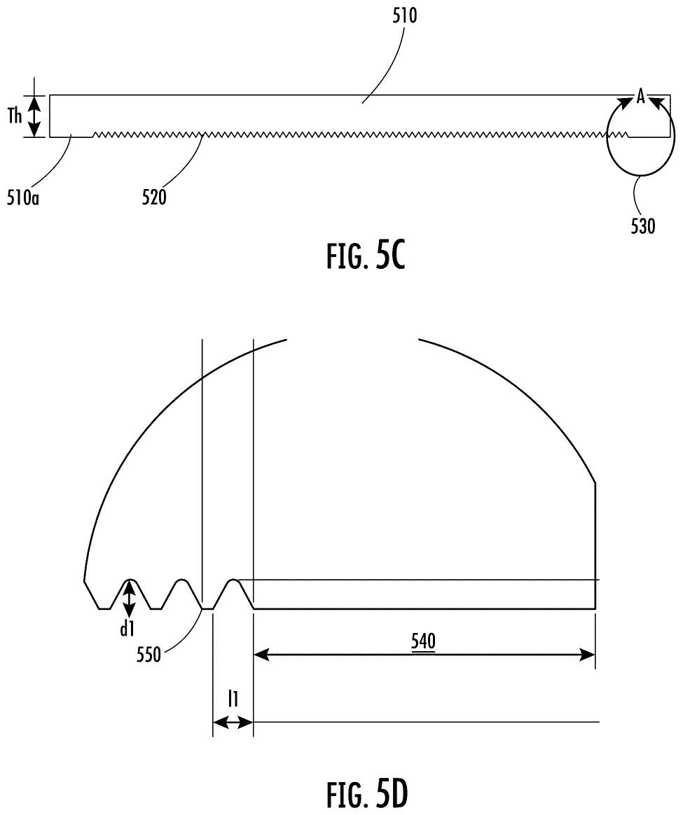

FIGS. 5A-5D illustrate example aspects of the micro-channels which may be provided in a glass block, according to some implementations of the disclosure.

For example, FIGS. 5A-5B illustrate a glass block 510 having a rectangular prism or rectangular cuboid shape. In the example of FIGS. 5A-5B, the glass block 510 includes a plurality of micro-channels 520 which are provided on a side 510a of the glass block 510. In some implementations, the plurality of micro-channels 520 may be provided on additional sides of the glass block 510. In the example of FIGS. 5A-5B, the plurality of micro-channels 520 are provided on a first portion 520a of the side 510a and remaining portions (e.g., portion 510b and portion 510c) may not be provided with the plurality of micro-channels 520. For example, the remaining portions may be end portions as shown in FIGS. 5A-5B. In some implementations, the plurality of micro-channels 520 may be provided on the entire surface of the side 510a of the glass block 510.

FIGS. 5C-5D illustrate cross-sectional views of the glass block 510. In the example of FIGS. 5C-5D, the glass block 510 includes a plurality of micro-channels 520 which are provided on the side 510a of the glass block 510. FIG. 5D illustrates an exploded view of portion 530 shown in FIG. 5C. The plurality of micro-channels 520 may have a triangular shape (e.g., with rounded or beveled corners). For example, the plurality of micro-channels 520 may have a height dl which is less than about one micrometer to about less than one hundred micrometers. The plurality of micro-channels 520 may be spaced apart by a distance ll which is less than about one micrometer to about less than one hundred micrometers. For example, the plurality of micro-channels 520 may have a same height and/or length, however in some implementations the plurality of micro-channels 520 may each have different dimensions. For example, each protrusion 550 (notch, tooth, groove, etc.) of the plurality of micro-channels 520 may be spaced apart by regular intervals or irregular intervals. In some implementations, the plurality of micro-channels 520 may be shaped differently (e.g., half-circular shaped, square shaped, etc.). In some implementations, the plurality of micro-channels 520 may be formed on an entirety of a side surface of the glass block 510. In some implementations, the plurality of micro-channels 520 may be formed on a portion of a side surface of the glass block 510 and another portion 540 which is devoid of the plurality of micro-channels 520.

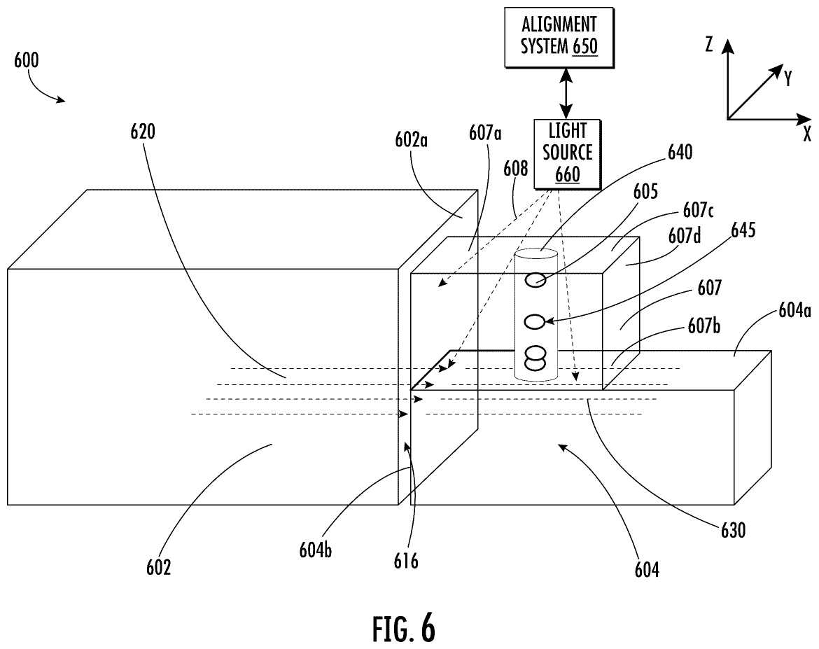

FIG. 6 depicts an example optical system 600 for a LIDAR system, according to some implementations of the disclosure. The optical system 600 can be included in a LIDAR system, such as the LIDAR system 200 of FIG. 2 and the like.

In FIG. 6, the optical system 600 may include a first optical component 602 and a second optical component 604 that are butt-coupled (or edge-coupled) together. For example, the first optical component 602 and the second optical component 604 may correspond to silicon chips, for example silicon chips with multi-channel waveguides (e.g., a four-channel waveguides). However, the first optical component 602 and the second optical component 604 may correspond to other types of semiconductor optical devices (e.g., silicon photonic chips, III-IV chips, etc.). In some implementations, the first optical component 602 may correspond to an optical sub-assembly and the second optical component 604 may correspond to a laser array chip.

In the example of FIG. 6, a glass block 607 is further provided and implemented to couple the first optical component 602 with the second optical component 604 by providing coupling material between the first optical component 602 and the glass block 607 (e.g., between a first side 607a of the glass block 607 and a first side 602a of the first optical component 602) and between the second optical component 604 and the glass block 607 (e.g., between a second side 607b of the glass block 607 and a first side 604a of the second optical component 604); and between the first optical component 602 and the second optical component 604 (e.g., between the first side 602a of the first optical component 602 and a second side 604b of the second optical component 604). The configuration of the glass block 607 can secure the first optical component 602 and the second optical component 604 in a reliable manner with sufficient mechanical strength so that the first optical component 602 and the second optical component 604 are properly aligned. For example, the first side 602a of the first optical component 602 may be perpendicular to the first side 604a of the second optical component 604.

In some implementations, the coupling material may have a thickness of about one micrometer or a sub-micrometer thickness (e.g., less than one micrometer). For example, the coupling material may be a polymer material, for example an ultraviolet polymer material. For example, the coupling material may be an epoxy, for example an ultraviolet epoxy.

In some implementations, the glass block 607 may be positioned adjacent to or next to the first optical component 602 (to the side in the x-axis direction) and over (above in the z-axis direction) the second optical component 604. The first optical component 602 and the second optical component 604 are butt-coupled together in an end-to-end manner (e.g., along the x-axis). In some implementations, the first optical component 602 and the second optical component 604 may have the same size in one or more dimensions: the same height (e.g., in the z-axis direction), the same length (e.g., in the x-axis direction), and/or the same width (e.g., in the y-axis direction). However, the first optical component 602 and the second optical component 604 may have different sizes in one or more dimensions. In the example of FIG. 6, the glass block 607 has a rectangular prism shape. In the example of FIG. 6, the first optical component 602 and the second optical component 604 are shaped differently, with the first optical component 602 having a greater height in the z-axis direction than the second optical component 604. For example, a surface area of the first side 602a that is in contact with the glass block 607 may be the same as or greater than a surface area of the first side 602a that is in contact with the second side 604b of the second optical component 604. For example, the first optical component 602 may have a height about twice as great as the height of the second optical component 604. For example, the vertical height of the first optical component 602 may be about a few hundred micrometers to about a couple of millimeters.

For example, the glass block 607 may have a length or width (e.g., in the x-axis direction) of about a few hundred micrometers to about a few tenths of a millimeter. For example, the glass block 607 may have a first thickness or height (e.g., in the vertical or z-axis direction measured from the second side 607b of the glass block 607 which faces the first side 604a of the second optical component 604 to an opposite side 607c of the glass block 607) of about a few hundred micrometers to about less than one hundred millimeters. For example, the glass block 607 may have a length or width w (e.g., in the horizontal or x-axis direction measured from the first side 607a of the glass block 607 which faces the first side 602a of the first optical component 602 to the opposite side 607d of the glass block 607) which is about half as long as a width of the second optical component 604 in the horizontal or x-axis direction.

In some implementations, the first optical component 602 may include one or more first waveguides 620 (e.g., 4-channel waveguides) and the second optical component 604 may include one or more second waveguides 630 (e.g., 4-channel waveguides). In an example implementation, the first waveguides 620 and the second waveguides 630 may be positioned at a same height so as to be optically aligned. For example, the one or more first waveguides 620 may be provided near or at a center or central portion of the first optical component 602. For example, the one or more second waveguides 630 may be provided near or at an upper or top portion (surface or upper active surface) of the first side 604a of the second optical component 604 (e.g., about a few micrometers from the upper or top portion (surface or upper active surface) of the first side 604a of the second optical component 604).

In some implementations, the glass block 607 may be positioned in a manner on the first side 602a of the first optical component 402 and the first side 604a of the second optical component 604 such that the first side 607a of the glass block 607 covers a same surface area amount with respect to the first optical component 602 as the second side 607b of the glass block 607 covers the second optical component 604. Therefore, a uniform mechanical strength may be achieved with respect to the first optical component 602 and the second optical component 604. In some implementations, the glass block 607 may be positioned in a manner on the first side 602a of the first optical component 402 and the first side 604a of the second optical component 604 such that the first side 607a of the glass block 607 covers a greater surface area amount with respect to one of the first optical component 602 and the second optical component 604 compared to the other of the first optical component 602 and the second optical component 604.

In some implementations, the glass block 607 includes a plurality of micro-channels which are provided in one or more of the first side 607a and the second side 607b. For example, the micro-channels may be formed through a mechanical machining process, a chemical etching process, etc. For example, the alignment system 650 may be configured to dispense the liquid coupling material 605 at the first side 607a and/or at the second side 607b, for example, in the micro-channels. The liquid coupling material 605 (e.g., liquid UV material) may naturally flow from one side of the micro-channels to another, for example, under the capillary force effect. For example, the liquid coupling material 605 may be provided at the interface between the first side 607a of the glass block 607 and the first side 602a of the first optical component 602 and at the interface between the second side 607b of the glass block 607 and the first side 604a of the second optical component 604. In some embodiments, the liquid coupling material 605 may also fill an area between the first optical component 602 and the second optical component 604 (e.g., at the interface where the first optical component 602 is coupled to the second optical component 604).

In the example of FIG. 6, the glass block 607 can include a through-hole 640 (e.g., a center through-hole) of a reservoir 645 which extends from the side 607c to the second side 607b. The through-hole 640 may have a diameter of about a couple hundred micrometers or up to about a couple of millimeters (less than the length and width of the glass block 607 in the x-axis and y-axis directions). The through-hole 640 can be configured with an inlet which receives the liquid coupling material 605, and the reservoir 645 channels the liquid coupling material 605 to the first side 604a of the second optical component 604. A method for providing the liquid coupling material 605 to the glass block 607 may include the alignment system 650 dispensing the liquid coupling material 605 (e.g., liquid UV droplets) into the inlet of the through-hole 640. The through-hole and reservoir design can improve the liquid coupling material dispensing process significantly.

After the liquid coupling material 605 is provided and a target alignment accuracy is achieved (e.g., where the one or more first waveguides 620 and the one or more second waveguides 630 are optically aligned), the light source 660 may be configured to apply a light 608 to the second side 607b (e.g., an upper or top surface) of the glass block 607. The light 608 is transmitted through the glass block 607 to cure the liquid coupling material 605 within the micro-channels and the interfaces between the glass block 607 and the first optical component 602 and the second optical component 604. This curing process (e.g., a UV curing process) enhances the mechanical strength to hold the first optical component 602 and the second optical component 604 together. In some implementations, the alignment system 650 may be configured to implement a thermal curing process after the ultraviolet light curing, to fully cure the liquid coupling material 605 (which becomes coupling material 616, for example) between the first optical component 602 and the second optical component 604, where the light 608 cannot achieve sufficient curing.

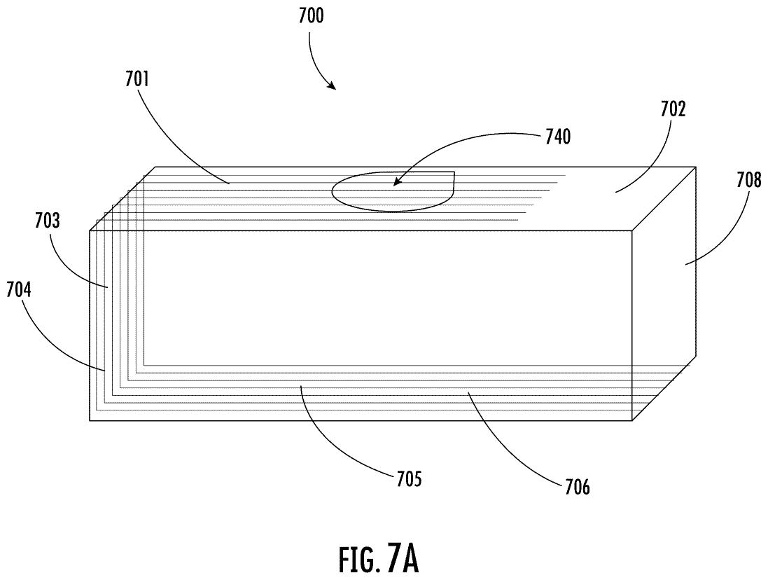

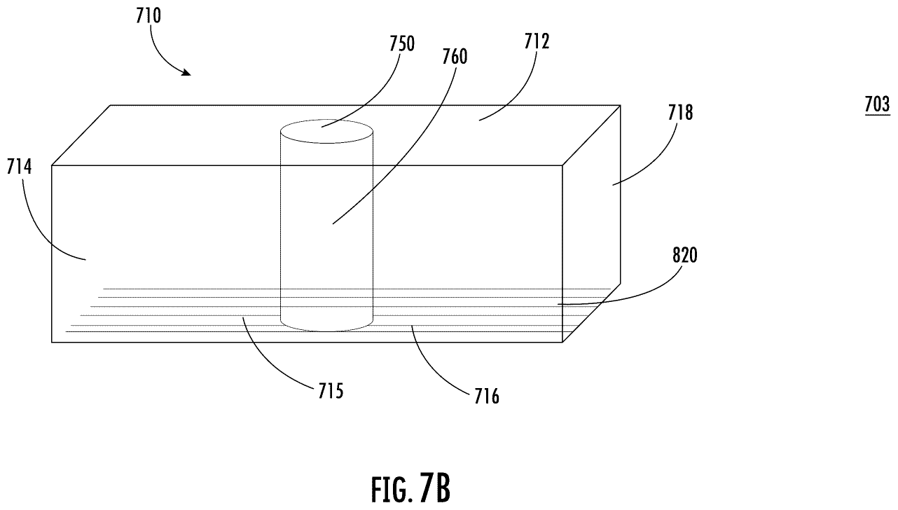

FIGS. 7A-7B are examples of glass blocks having holes for facilitating the dispensing of liquid coupling material to micro-channels of the glass block, according to some implementations of the disclosure. Referring to FIG. 7A, the glass block 700 includes a first side 702, a second side 704, a third side 706, and a fourth side 708. A first plurality of micro-channels 701 are provided on the first side 702, a second plurality of micro-channels 703 are provided on the second side 704, and a third plurality of micro-channels 705 are provided on the third side 706. A through-hole 740 is provided on the first side 702, for example, at a central portion of the first side 702, where the first plurality of micro-channels 701 are located. As shown in FIG. 7A, the first plurality of micro-channels 701 do not extend across the entirety of first side 702 (e.g., the first plurality of micro-channels 701 do not extend to the fourth side 708). In contrast, the second plurality of micro-channels 703 extend across the entirety of second side 704 (e.g., from the first side 702 to the third side 706), and the third plurality of micro-channels 705 extend across the entirety of third side 706 (e.g., from the second side 704 to the fourth side 708). When the liquid coupling material (e.g., ultraviolet liquid material) is dispensed on the top or upper surface of the first side 702, the first plurality of micro-channels 701 will guide the liquid coupling material to flow to a side surface (e.g., the second side 704), then downwards and to the bottom side (e.g., the third side 706), and then the liquid coupling material flows from the second side 704 to the fourth side 708 (e.g., in a left to right direction).

Referring to FIG. 7B, the glass block 710 includes a first side 712, a second side 714, a third side 716, and a fourth side 718. A first plurality of micro-channels 715 are provided on the third side 716. A through-hole 750 is provided on the first side 712, for example, at a central portion of the first side 712. As shown in FIG. 7B, the first plurality of micro-channels 715 extend across the entirety of third side 716 (e.g., from the second side 714 to the fourth side 718). For example, when the liquid coupling material (e.g., ultraviolet liquid material) is dispensed or jetted into an inlet of the through-hole 750 provided on the top or upper surface of the first side 712, the liquid coupling material flows through the reservoir 760 to the first plurality of micro-channels 715 which are configured to guide the liquid coupling material to flow to the side surfaces (e.g., the second side 714 and the fourth side 718).

In some implementations, the glass block may include a plurality of through-holes and/or a plurality of reservoirs, to transport the liquid coupling material.

Described herein are methods for manufacturing a semiconductor-based LIDAR system for a vehicle, which can ensure that specification requirements are satisfied. As described in more detail herein, the method may be implemented to securely couple a plurality of optical components for an optical system provided.

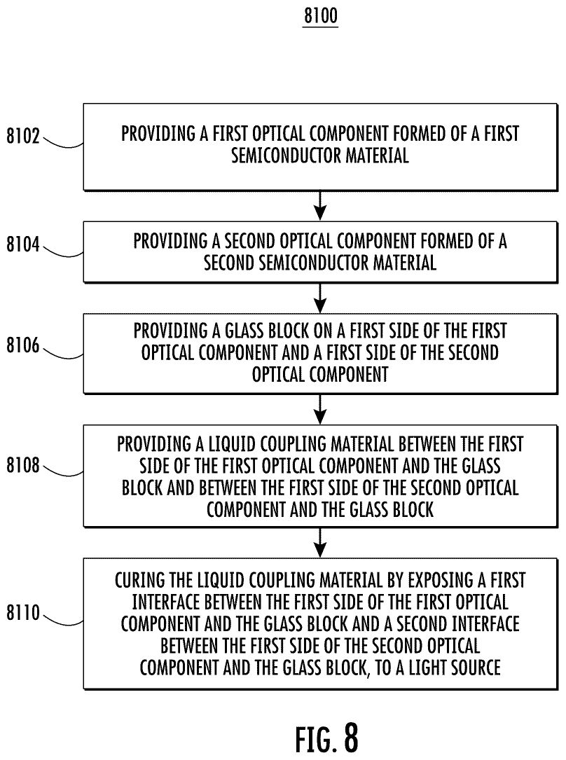

FIG. 8 is a flow diagram of an example, non-limiting method, according to one or more example embodiments of the disclosure.

The flow diagram of FIG. 8 illustrates a method 8100 for manufacturing a semiconductor-based LIDAR sensor system for a vehicle, according to some implementations of the disclosure. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. For example, the LIDAR sensor system may correspond to the LIDAR system 200 of FIG. 2.

Referring to FIG. 8, at operation 8102, the method 8100 includes providing a first optical component formed of a first semiconductor material. For example, the first optical component may correspond to a silicon chip, for example a silicon chip with a multi-channel waveguide (e.g., a three-channel waveguide, a four-channel waveguide, etc.) or other types of semiconductor optical devices (e.g., silicon photonic chips, III-IV chips, etc.). For example, the first optical component can correspond to any of first optical components 402, 412, 422, 602.

At operation 8104, the method 8100 includes providing a second optical component formed of a second semiconductor material. For example, the second optical component may correspond to a silicon chip, for example a silicon chip with a multi-channel waveguide (e.g., a three-channel waveguide, a four-channel waveguide, etc.) or other types of semiconductor optical devices (e.g., silicon photonic chips, III-IV chips, etc.). For example, the second optical component can correspond to any of second optical components 404, 414, 424, 604.

At operation 8106, the method 8100 includes providing a glass block on a first side of the first optical component and a first side of the second optical component. For example, the glass block can be shaped as a rectangular prism (e.g., having a cubic shape), can have a stepped shape, etc. For example, the glass block may have a length or width of about a few hundred micrometers to about a few tenths of a millimeter. For example, the glass block may have a thickness or height of about a few hundred micrometers to about less than one hundred millimeters. In some implementations, the glass block may include a plurality of micro-channels provided on one or more sides of the glass block. For example, the glass block can correspond to any of glass blocks 407, 417, 427, 510, 607, 700, 710.

At operation 8108, the method 8100 includes providing a liquid coupling material between the first side of the first optical component and the glass block and between the first side of the second optical component and the glass block. For example, the liquid coupling material may be a polymer material, for example an ultraviolet polymer material. For example, the liquid coupling material may be an epoxy, for example an ultraviolet epoxy. In some implementations, the liquid coupling material may be provided via a through-hole that is provided on a side of the glass block. For example, in some implementations the liquid coupling material may be provided between a first side of the first optical component and the glass block and between a first side of the second optical component and the glass block. For example, the liquid coupling material may be provided through a through-hole (or reservoir) which extends from a first side of the glass block to a second side of the glass block.

In some implementations, the glass block includes a plurality of micro-channels on a plurality of sides of the glass block and at least one hole provided at a first side among the plurality of sides of the glass block. For example, the liquid coupling material may be provided between a first side of the first optical component and the glass block and between a first side of the second optical component and the glass block. For example, the liquid coupling material may be provided through the at least one hole, guiding the liquid coupling material from a first plurality of micro-channels on the first side among the plurality of sides of the glass block to a second plurality of micro-channels on a second side among the plurality of sides of the glass block, and guiding the liquid coupling material from the second plurality of micro-channels to a third plurality of micro-channels on a third side among the plurality of sides of the glass block. For example, the third side (e.g., second side 607b in FIG. 6) among the plurality of sides of the glass block may face at least one of the first side of the of the first optical component and the first side of the second optical component (e.g., first side 604a in FIG. 6).

At operation 8110, the method 8100 includes curing the liquid coupling material by exposing a first interface between the first side of the first optical component and the glass block and a second interface between the first side of the second optical component and the glass block, to a light source. For example, after the liquid coupling material is provided and a target alignment accuracy is achieved between the first optical component and the second optical component, a light source may be configured to apply a light to a surface (e.g., an upper or top surface) of the glass block. The light is transmitted through the glass block to cure the liquid coupling material (e.g., which may be provided within micro-channels of the glass block and at the interface(s) between the glass block and the first optical component and the second optical component. This curing process (e.g., a UV curing process) enhances the mechanical strength to hold the first optical component and the second optical component together. In some implementations, an alignment system may be configured to implement a thermal curing process after the ultraviolet light curing, to fully cure the liquid coupling material between the first optical component and the second optical component, for example, where the light cannot achieve sufficient curing.

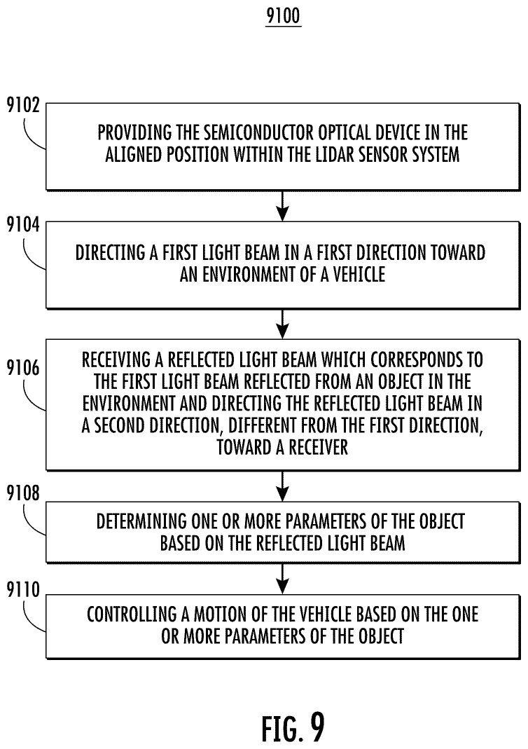

FIG. 9 is a flow chart of an example, non-limiting computer-implemented method, according to one or more example embodiments of the disclosure.

The flow chart of FIG. 9 illustrates a method 9100 for controlling a vehicle, according to some implementations of the disclosure. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The method 9100 may be an extension of the method of FIG. 8. However, in some implementations the method 9100 may be a standalone method (e.g., for testing or implementing a semiconductor optical device in a LIDAR system and/or for controlling a vehicle). Referring to FIG. 9, at operation 9102, the method 9100 includes providing the semiconductor optical device in the aligned position where the semiconductor optical device (e.g., which can comprise the first optical component and the second optical component coupled together via the glass block) is properly aligned (positioned) within the LIDAR sensor system. For example, the semiconductor optical device may be provided in the aligned position after performing the operations of FIG. 8 which can include one or more curing processes (e.g., a UV curing process and a thermal curing process).

At operation 9104, the method 9100 includes directing a first light beam in a first direction toward an environment of the vehicle. For example, the first light beam may correspond to outgoing light transmitted via the transmitter 220 in FIG. 2 to the object 218.

At operation 9106, the method 9100 includes receiving a reflected light beam which corresponds to the first light beam reflected from the object in the environment and directing the reflected light beam in a second direction, different from the first direction, toward a receiver (e.g., receiver 222 in FIG. 2). For example, the reflected light beam may correspond to incoming light which has been reflected off object 218 which may be in an environment of the vehicle. Further, the incoming light may be directed toward receiver 222 in FIG. 2.

At operation 9108, the method 9100 includes determining one or more parameters of the object based on the reflected light beam. For example, as described herein, one or more of the parameters of the object (e.g., object 218) can be determined based on sensor data collected by the LIDAR sensor system. For example, the LIDAR sensor system may output sensor data 104 which can be processed by one or more sub-control system(s) 101 shown in FIG. 1 to determine the parameters of the object. For example, the parameters of the object can include map or location data associated with the object, distance information associated with the object, identification or classification information associated with the object, motion information associated with the object, etc.

At operation 9110, the method 9100 includes controlling a motion of the vehicle based on the one or more parameters of the object. For example, as described herein, one or more of the sub-control system(s) 101 shown in FIG. 1 can be implemented to control a motion of the vehicle based on the one or more parameters of the object (e.g., by generating a motion plan, by selecting a motion plan, by controlling braking, acceleration, and/or steering components of the vehicle, etc.).

The foregoing describes the technology of this disclosure within the context of a LIDAR system and an autonomous vehicle for example purposes only. As described herein, the technology described herein is not limited to a LIDAR system or an autonomous vehicle and can be implemented for or within other systems, autonomous platforms, and other computing systems.

What is claimed is:

1. A Light Detection and Ranging (LIDAR) sensor system, comprising:
an optical system, comprising:
a first optical component formed of a first semiconductor material;
a second optical component formed of a second semiconductor material;
a glass block disposed on a first side of the first optical component and a first side of the second optical component, the glass block comprising a plurality of micro-channels; and
a coupling material, disposed in the plurality of micro-channels, between the first side of the first optical component and the glass block and between the first side of the second optical component and the glass block.

2. The LIDAR sensor system of claim 1, wherein the coupling material is further disposed between a second side of the first optical component and a second side of the second optical component.

3. The LIDAR sensor system of claim 1, wherein the coupling material is an ultraviolet polymer material.

4. The LIDAR sensor system of claim 1, wherein the first side of the first optical component is perpendicular to the first side of the second optical component.

5. The LIDAR sensor system of claim 1, wherein the coupling material is disposed between a second side of the first optical component and at least two sides of the second optical component.

6. The LIDAR sensor system of claim 1, wherein:
the first optical component includes a first active surface disposed at a second side of the first optical component,
the second optical component includes a second active surface disposed at the first side of the second optical component, and
the first active surface includes a first plurality of waveguides which are aligned with a second plurality of waveguides included in the second active surface.

7. The LIDAR sensor system of claim 1, wherein an area of the glass block disposed on the first side of the first optical component is substantially the same as an area of the glass block disposed on the first side of the second optical component.

8. The LIDAR sensor system of claim 1, wherein:
one or more sides of the glass block face at least one of the first side of the first optical component and the first side of the second optical component, and
the one or more sides of the glass block comprise the plurality of micro-channels.

9. The LIDAR sensory system of claim 1, wherein
the plurality of micro-channels are disposed on a first side the glass block, and
the first side of the glass block faces the first side of the first optical component and the first side of the second optical component.

10. The LIDAR sensor system of claim 1, wherein the glass block comprises the plurality of micro-channels on at least three sides of the glass block.

11. The LIDAR sensor system of claim 1, wherein:
the glass block includes a through-hole which extends from a first side of the glass block to a second side of the glass block,
the second side of the glass block faces the first side of the first optical component and the first side of the second optical component, and
at least the second side of the glass block comprises the plurality of micro-channels.

12. The LIDAR sensor system of claim 1, wherein a thickness of the coupling material disposed between the first side of the first optical component and the glass block is less than one micrometer.

13. An autonomous vehicle (AV) control system for a vehicle, comprising:
one or more processors; and
the Light Detection and Ranging (LIDAR) sensor system of claim 1.

14. An autonomous vehicle, comprising:
an autonomous vehicle control system, the autonomous vehicle control system comprising one or more processors and a Light Detection and Ranging (LIDAR) sensor system, the LIDAR sensor system comprising:
a light source configured to emit a beam to be directed toward an object in an environment of the autonomous vehicle;
a first optical component formed of a first semiconductor material;
a second optical component formed of a second semiconductor material to receive the beam directed by the first optical component;
a glass block disposed on a first side of the first optical component and a first side of the second optical component, the glass block comprising a plurality of micro-channels; and
a coupling material, disposed in the plurality of micro-channels, between the first side of the first optical component and the glass block and between the first side of the second optical component and the glass block;
a receiver configured to receive a reflected beam from the object and determine an object detection associated with the object; and
an autonomous vehicle controller configured to control the autonomous vehicle based on the object detection associated with the object.

15. A method for manufacturing a semiconductor-based LIDAR sensor system for a vehicle, the method comprising:
providing a first optical component formed of a first semiconductor material;
providing a second optical component formed of a second semiconductor material;
providing a glass block comprising a plurality of micro-channels, the glass block being disposed on a first side of the first optical component and a first side of the second optical component;
providing a liquid coupling material in the plurality of micro-channels, the liquid coupling material being provided between the first side of the first optical component and the glass block and between the first side of the second optical component and the glass block; and
curing the liquid coupling material by exposing a first interface between the first side of the first optical component and the glass block and a second interface between the first side of the second optical component and the glass block, to a light source.

16. The method of claim 15, wherein
the light source is an ultraviolet light source, and curing the liquid coupling material comprises exposing the first interface between the first side of the first optical component and the glass block and the second interface between the first side of the second optical component and the glass block, to the ultraviolet light source, and
the method further comprises thermally curing the liquid coupling material after exposing the first interface between the first side of the first optical component and the glass block and the second interface between the first side of the second optical component and the glass block, to the ultraviolet light source.

17. The method of claim 15, wherein providing the liquid coupling material further comprises providing the liquid coupling material through a through-hole which extends from a first side of the glass block to a second side of the glass block.

18. The method of claim 15, wherein:
the plurality of micro-channels include a first plurality of micro-channels provided on a first side among a plurality of sides of the glass block and a second plurality of micro-channels provided on a second side among the plurality of sides of the glass block,
the glass block includes at least one hole disposed at the first side among the plurality of sides of the glass block, and
providing the liquid coupling material comprises providing the liquid coupling material through the at least one hole, guiding the liquid coupling material from the first plurality of micro-channels to the second plurality of micro-channels, and guiding the liquid coupling material from the second plurality of micro-channels to a third plurality of micro-channels on a third side among the plurality of sides of the glass block, wherein the third side among the plurality of sides of the glass block faces at least one of the first side of the of the first optical component and the first side of the second optical component.

19. The method of claim 15, wherein
the plurality of micro-channels are disposed on a first side the glass block and the first side of the glass block faces the first side of the first optical component and the first side of the second optical component, and
providing the liquid coupling material comprises guiding the liquid coupling material via the plurality of micro-channels in a direction from the first side of the first optical component to the first side of the second optical component.

20. The method of claim 15, wherein
the plurality of micro-channels include a first plurality of micro-channels disposed on a first side the glass block and a second plurality of micro-channels disposed on a second side of the glass block,
the first side of the glass block faces the first side of the first optical component and the second side of the glass block faces the first side of the second optical component, and
providing the liquid coupling material comprises guiding the liquid coupling material to flow in a first direction along the first plurality of micro-channels parallel to the first side of the first optical component to flow in a second direction along the second plurality of micro-channels parallel to the first side of the second optical component.
